(19) United States
(12) Patent Application Publication
(10) Pub. No.: US 2010/0233491 A1
(43) Pub. Date: Sep. 16, 2010

(54) Anisotropic Polymeric Film and Method of Production Thereof

(75) Inventors: Alexey Nokel, Moscow (RU); Pavel I. Lazarev, London (GB)

Correspondence Address: HOUST CONSULTING (Kont), P.O. BOX 2688, SARATOGA, CA, 95070-0688, US

(73) Assignee: CRYSOPTIX KK, Tokyo (JP)

(21) Appl. No.: 12/377,091

(22) PCT Filed: Aug. 16, 2007
(86) PCT No.: PCT/GB2007/003123

§ 371 Date: Feb. 10, 2009

(30) Foreign Application Priority Data
Aug. 16, 2006 (GB) 0616358.8

(51) Int. Cl. B32B 17/06; C08G 73/06; B05D 3/02

(52) U.S. Cl. 428/426; 528/423; 428/411.1; 427/385.5

(57) ABSTRACT

The present invention relates generally to the field of organic chemistry and particularly to anisotropic polymer films. More specifically, the present invention relates to materials for microelectronics, optics, communications, computer technology, and other related fields. The invention provides an anisotropic polymeric film and method of producing the same, which film comprises a substrate and an anisotropic layer of noncovalent polymeric material. The anisotropic layer comprises a mixture of general composition (I) where Hetᵢ is a heterocyclic molecular system of the i-th kind, K is the number of different kinds of heterocyclic molecular system in the mixture and is equal to 1, 2, 3, 4, 5 or 6; i is an integer in the range from 1 to K; P₁, P₂, . . . P_{K} are real numbers in the range from 0 to 1 and obey the condition: P₁+P₂+ . . . +P_{K}=1, A is a molecular binding group, n being 2, 3, 4, 5, 6, 7 or 8, B is a molecular group ensuring solubility of the heterocyclic molecular system, m being 0, 1, 2, 3, 4, 5, 6, 7, or 8, R1 is a substituent group from the list comprising —CH₃, —C₂H₅, —NO₂, —CI, —Br, —F, —CF₃, —CN, —CNS, —OH, —OCH₃, —OC₂H₅, —OCOCH₃, —OCN, —SCN —NH₂, —NHCOCH₃, and —CONH₂, z being 0, 1, 2, 3 or 4, St is a molecular group serving as a sticker, Px is a real number in the range from 0 to 1, Sp is a molecular group serving as a stopper, and Py is a real number in the range from 0 to 1, wherein said binding groups are predominantly oriented so as to ensure anisotropic optical properties of the polymer film.

The present invention relates generally to the field of organic chemistry and particularly to anisotropic polymer films. More specifically, the present invention relates to materials for microelectronics, optics, communications, computer technology, and other related fields.

The development of modern technology requires creating new materials—in particular, polymers—which serve a basis for fabricating optical, electronic, and other elements with desired anisotropic properties. A special class of polymers is represented by supramolecular polymers, [see, e.g., L. Brandveld, Supramolecular Polymers, Chem. Rev., 101, 4071-4097 (2001)], in which the structural particles (monomers) are linked by noncovalent bonds such as hydrogen bonds (H-bonds), complex bonds, and arene-arene bonds. The monomers represent self-assembly discotic molecules, typically of organic dyes, containing various substituted ionic groups. In aqueous solutions, such discotic molecules exhibit aggregation with the formation of a lyotropic liquid crystal.

An important role of intermolecular links of the H-bond type in the formation of supramolecular polymer compositions was described, for example, in European Patent EP 1,300,447. Such bonds appear as a result of the interaction between functional groups of adjacent polymer chains.

The U.S. Pat. No. 5,730,900 discloses a method of obtaining a film based on a supramolecular polymer matrix. According to the disclosed method, an initial solution comprises a mixture of discotic substituted polycyclic compounds, containing polymerizable groups in the substituents, and, a liquid-crystalline compound. The substrate is made of an oriented polymeric material. After the disclosed treatment and subsequent cooling, a film is formed comprising a polymer matrix and the liquid-crystalline compound. The conversion of a two-component mixture leads to the formation of a matrix polymer system with protective layers, retaining the liquid-crystalline properties in the final film. However, the use of organic solvents (with the need for selecting individual solvents for the system, components) and the required high-temperature and/or UV radiation treatments make the aforementioned polymerization process technologically complicated and not ecologically safe.

Another promising class of compounds for obtaining modified anisotropic thin crystal films possessing new properties is offered by modified water-soluble dichroic organic dyes with planar molecular structures. The process of manufacturing thin crystal films based on such materials does not have disadvantages inherent in the technology of the prior art. The manufacturing process includes the following stages. In the first stage, a water-soluble dye forms a lyotropic liquid crystal phase. This phase comprises columnar aggregates composed of discotic molecules of the dichroic dyes [see, e.g., P. Yeh et al., Molecular Crystalline Thin Film E-Polarizer, Mol. Mater., 14 (2000)]. These molecules are capable of aggregating even in dilute solutions [see J. Lydon, Chromonics, in: Handbook of Liquid Crystals, pp. 981-1007 (1998)]. In the second stage, application of the lyotropic liquid crystal phase (in the form of ink or paste) with shear aligns molecular columns in the direction of shear. High thixotropy of the applied liquid crystal provides high molecular ordering in the shear-induced state and ensures its preservation after termination of the shear action. In the third stage of the process, evaporation of the solvent (water) leads to unidirectional crystallization with the formation of an organic solid crystal film from the pre-oriented liquid crystal phase. Such Thin Crystal Films (TCFs) are characterized by high optical anisotropy of refraction and absorption indices, exhibit the properties of extraordinary polarizers [as described in more details in Yu. A. Bobrov, J. Opt. Technol., 66, 547 (1999)] and can be used for commercial application in liquid crystal displays [as was generally described by L. Ignatov et al., Society for Information Display, Int. Symp. (Long Beach, Calif., May 16-18), Digest of Technical Papers, 31, 834-838 (2000)]. The application of anisotropic TCFs manufactured using this technology is limited in high-humidity environment. Said films may be additionally treated with a solution containing ions of bi- or trivalent metals. As a result of this treatment, a non-soluble TCF is formed.

In a first aspect, the present invention provides an anisotropic polymer film possessing improved working characteristics, including high mechanical strength and hydrolytic stability with respect to environmental factors. This anisotropic polymer film comprises a substrate and an anisotropic layer of a noncovalent polymeric material. The anisotropic layer comprises a mixture of general composition (I):

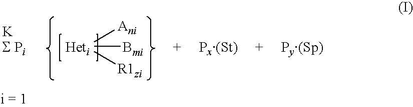

where Hetᵢ is a heterocyclic molecular system of the i-th kind, K is the number of different kinds of heterocyclic molecular system in the mixture and is equal to 1, 2, 3, 4, 5 or 6, i is an integer in the range from 1 to K, P₁, P₂, . . . P_{K} are real numbers in the range from 0 to 1 and obey the condition: P₁+P₂+ . . . +P_{K}=1, A and B are molecular groups, where A is a binding group and B is a molecular group ensuring solubility of the heterocyclic molecular system, n is 2, 3, 4, 5, 6, 7 or 8, m is 0, 1, 2, 3, 4, 5, 6, 7, or 8, R1 is a substituent group from the list comprising —CH₃, —C₂H₅, —NO₂, —CI, —Br, —F, —CF₃, —CN, —CNS, —OH, —OCH₃, —OC₂H₅, —OCOCH₃, —OCN, —SCN —NH₂, —NHCOCH₃, and —CONH₂, z is 0, 1, 2, 3 or 4, St is a molecular group serving as a sticker, Px is a real number in the range from 0 to 1, Sp is a molecular group serving as a stopper, and Py is a real number in the range from 0 to 1. Said binding groups are predominantly oriented so as to ensure anisotropic properties of the polymer film.

The present invention further provides a method for manufacturing an anisotropic polymer film possessing the disclosed properties. Accordingly, in a second aspect, the present invention provides a method which comprises: (i) preparing a substrate, and (ii) forming a solid layer of a noncovalently bound polymeric material on the substrate by means of a Cascade Polymerization process which comprises the steps of

(a) preparation of a reaction mixture of the general composition (II):

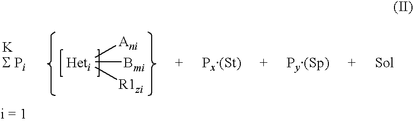

where Hetᵢ is a heterocyclic molecular system of the i-th kind, K is the number of different kinds of heterocyclic molecular system in the mixture and is equal to 1, 2, 3, 4, 5 or 6, i is an integer in the range from 1 to K, P₁, P₂, . . . P_{K} are real numbers in the range from 0 to 1 and obey the condition: P₁+P₂+ . . . +P_{K}=1, A and B are molecular groups, where A is a binding group and B is a molecular group ensuring solubility of the heterocyclic molecular system, n is 2, 3, 4, 5, 6, 7, or 8, m is 0, 1, 2, 3, 4, 5, 6, 7, or 8, R1 is a substituent group from the list comprising —CH₃, —C₂H₅, —NO₂, —CI, —Br, —F, —CF₃, —CN, —CNS, —OH, —OCH₃, —OC₂H₅, —OCOCH₃, —OCN, —SCN —NH₂, —NHCOCH₃, and —CONH₂, z is 0, 1, 2, 3, or 4, St is a molecular group serving as a sticker, Px is a real number in the range from 0 to 1, Sp is a molecular group serving as a stopper, Py is a real number in the range from 0 to 1, and Sol is a solvent;
(b) application of a liquid layer of the reaction mixture onto the substrate, and
(c) drying.

The coefficient Pᵢ in (I) and (II) is the weight multiplier showing the fraction of the heterocyclic molecular system Hetᵢ in the mixture. The coefficients Px and Py are the weight multipliers showing the amounts of sticker and stopper molecules, respectively, per heterocyclic molecular system (of any kind) in the mixture.

Anisotropic polymer films may contain two central components, heterocyclic molecular systems and molecular binding groups. These are defined as starting reagents from which the three-dimensional network structure of the anisotropic polymer film is constructed. In addition, other auxiliary components, including stickers and stoppers, may optionally be present. The important characteristics of stickers are the number and orientation of their binding sites (coordination numbers and coordination geometries). Transition-metal ions may be utilized as versatile stickers in the fabrication of anisotropic polymer films. Depending on the metal and its oxidation state, coordination numbers can range from 2 to 6, giving rise to various geometries of anisometric particles (polymer particles), which may be linear, T- or Y-shaped, tetrahedral, square-planar, square-pyramidal, trigonal-bipyramidal, octahedral, trigonal-prismatic, and pentagonal-bipyramidal. Stickers may be selected from the list comprising ions of hydrogen, bases, alkali metals, transition metals, platinum-group metals, and rare-earth metals, and preferably the stickers are selected from the list comprising NH⁴⁺, Na⁺, K⁺, Li⁺, Ba²⁺, Ca²⁺, Mg²⁺, Zn²⁺, Zr⁴⁺, Ce⁴⁺, Y³⁺, Yb³⁺, Gd³⁺, Er³⁺, Co²⁺, Co³⁺, Fe²⁺, Fe³⁺, and Cu²⁺.

Stoppers are polymer film components having one binding group. These components are intended for restriction of the sizes of anisometric particles during polymerization. They are arranged on the periphery of anisometric particles and stop the process of polymerization. Suitable stoppers include organic compounds having one binding group, for example one carboxylic group.

The general description of the present invention having been made, a further understanding can be obtained by reference to the specific preferred embodiments, which are given herein only for the purpose of illustration and are not intended to limit the scope of the appended claims provided below, and upon reference to the drawings, in which:

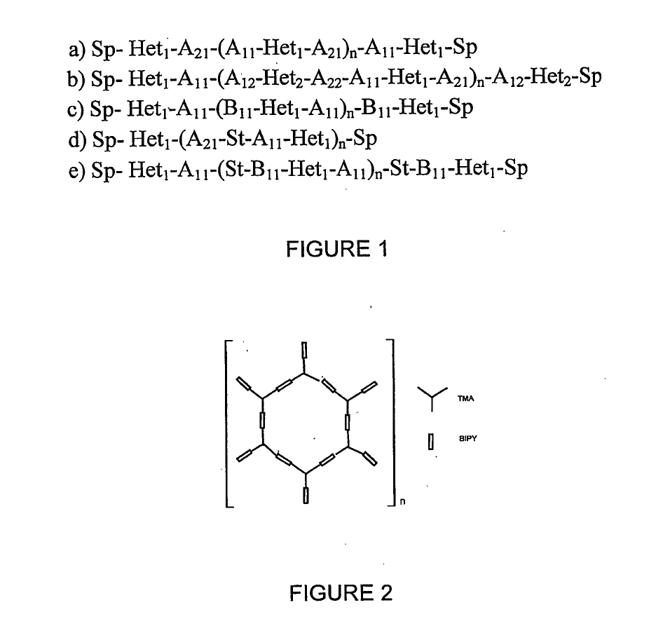

FIG. 1 provides several embodiments of the structure of linear polymer chains;

FIG. 2 shows the structure of a flat anisometric particle (polymer particle);

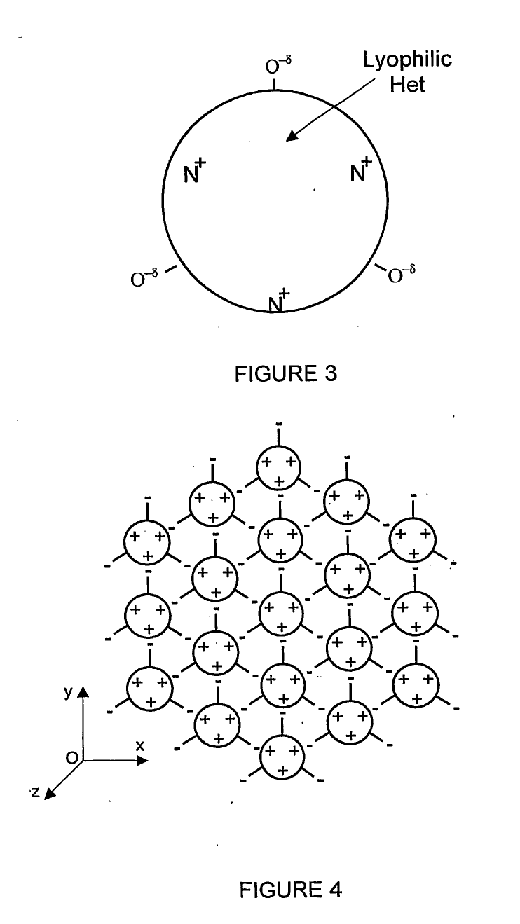

FIG. 3 schematically shows an organic compound comprising lyophilic disk-like heterocyclic molecular system (Het) with three binding groups;

FIG. 4 shows the structure of a flat anisometric particle formed by the heterocyclic molecular systems and binding groups depicted in FIG. 3;

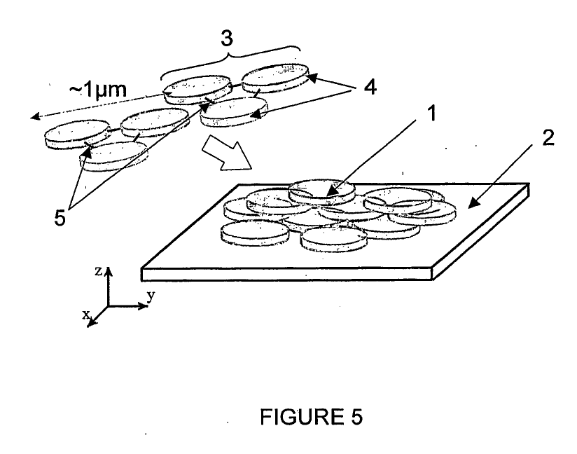

FIG. 5 illustrates the process of formation of an anisotropic polymer film;

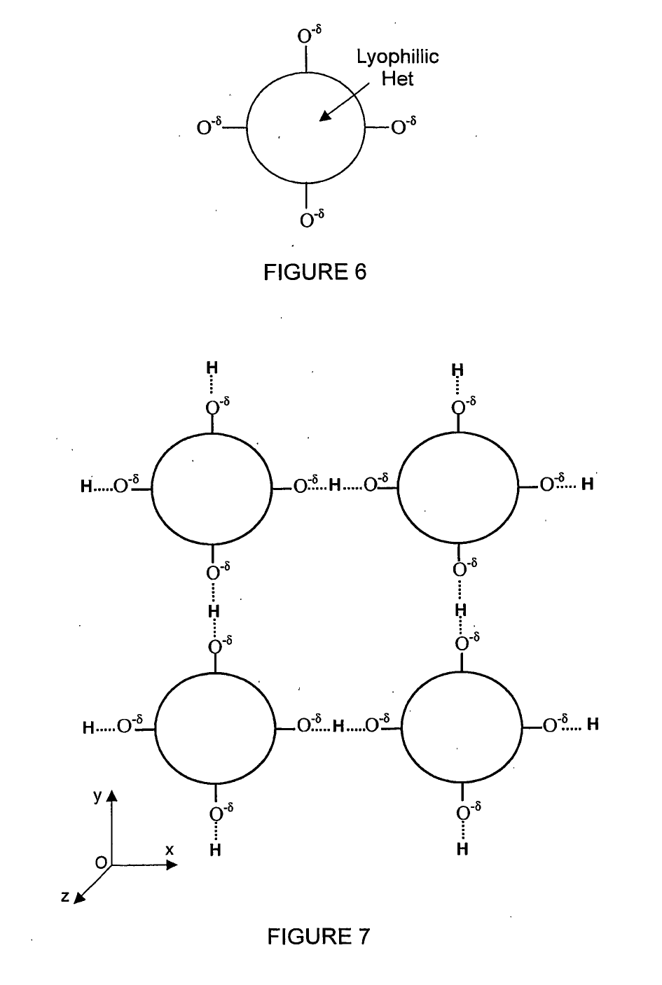

FIG. 6 schematically shows an organic compound comprising lyophilic disk-like heterocyclic molecular system (Het) with four binding groups;

FIG. 7 shows the structure of a flat anisometric particle formed by the heterocyclic molecular systems and binding groups depicted in FIG. 6.

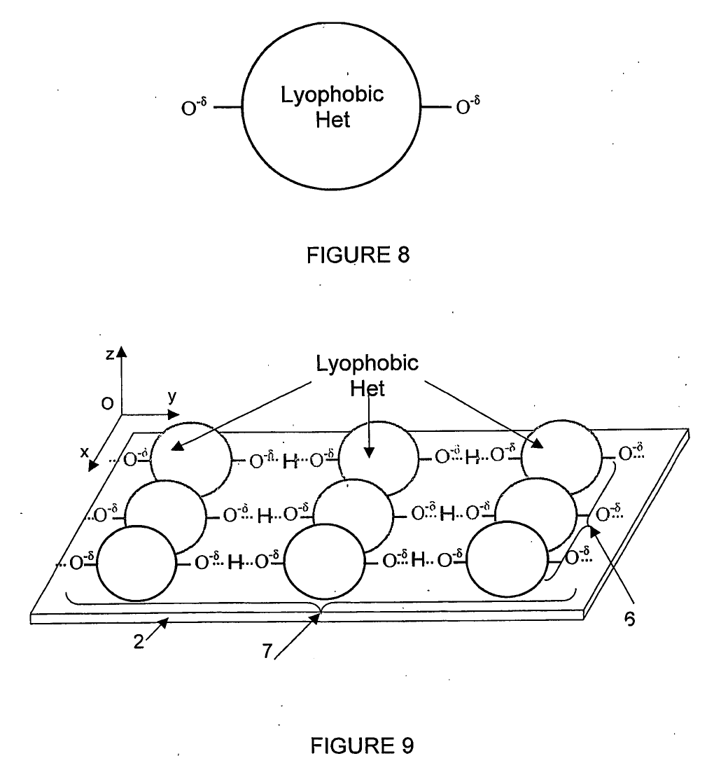

FIG. 8 schematically shows an organic compound comprising lyophobic disk-like heterocyclic molecular system (Het) with two binding groups;

FIG. 9 is a schematic diagram of an anisotropic solid layer formed on a substrate by heterocyclic molecular systems and binding groups depicted in FIG. 8;

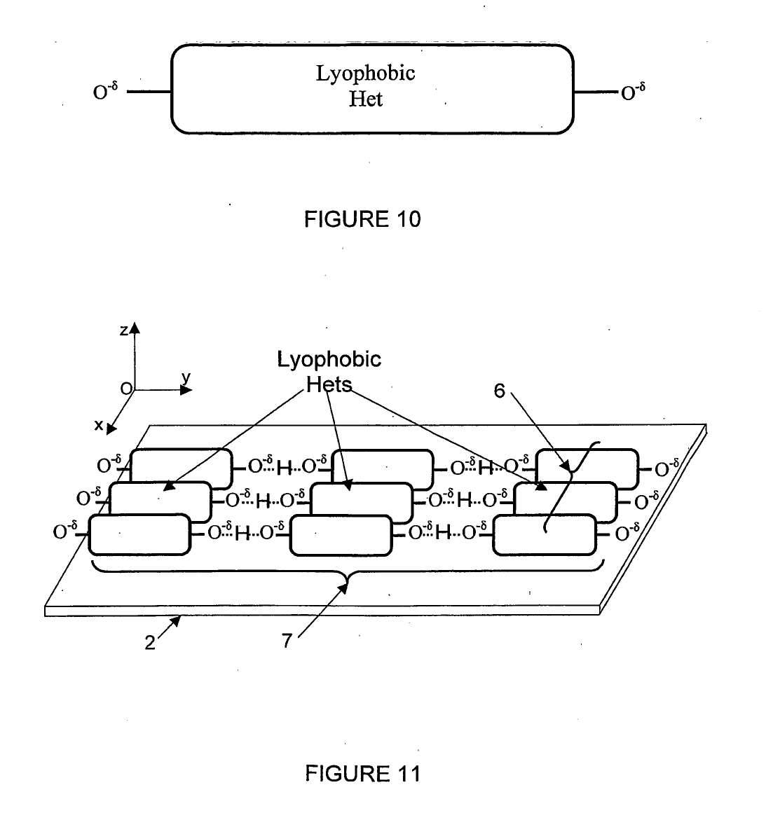

FIG. 10 is a schematic diagram of an organic compound comprising lyophobic ribbon-like heterocyclic molecular system (Het) with two binding groups;

FIG. 11 shows the structure of an anisotropic solid layer formed on a substrate by heterocyclic molecular systems and binding groups depicted in FIG. 10;

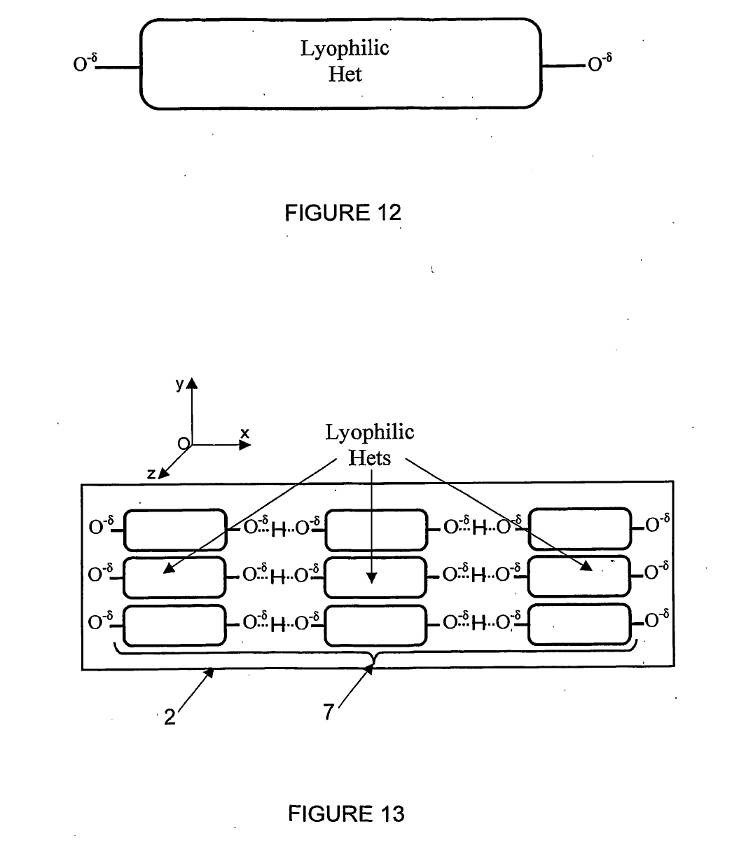

FIG. 12 is a schematic diagram of an organic compound comprising lyophilic ribbon-like heterocyclic molecular system with two binding groups; and

FIG. 13 shows the structure of an anisotropic solid layer formed on a substrate by heterocyclic molecular systems and binding groups depicted in FIG. 12.

In one embodiment of the anisotropic polymer film the anisotropic layer, is produced with the Cascade Polymerization process as presented below. In one embodiment of the disclosed anisotropic polymer film, the molecular binding group A is anisotropically polarizable. In another embodiment of the disclosed anisotropic polymer film, at least one of the binding groups is an acid binding group, and the acid binding groups are preferably selected from the list comprising COO, SO₃⁻, HPO₃⁻, PO₃²⁻, and any combination thereof. In still another embodiment of the disclosed anisotropic polymer film, at least one of the binding groups is a basic binding group and the basic binding groups are preferably selected from the list comprising NHR, NR₂, CONHCONH₂, CONH₂, and any combination thereof, where radical R is alkyl or aryl. In yet another embodiment of the disclosed anisotropic polymer film, the alkyl group is selected from the list comprising methyl, ethyl, propyl, i-propyl, butyl, i-butyl, s-butyl and t-butyl groups, and the aryl group is selected from the list comprising phenyl, benzyl and naphthyl groups. Preferred alkyl and aryl groups are listed below:

### Alkyl Groups:

General formula: CH₃(CH₂)ₙ— or CₙH₂ₙ₊₁ where n is equal to from 1 to 23.

### Examples

methyl(CH₃—), ethyl(C₂H₅—), propyl(C₃H₇—), butyl(C₄H₉—), i-butyl((CH₃)₂CHCH₂—), s-butyl (CH₃CH(CH₂CH₃)—, t-butyl((CH₃)₃C—), i-propyl(C₃H₇)

### Aryl Groups:

### Examples

phenyl(C₆H₅—), benzyl(C₇H₇—), naphthyl(C₇H₇—).

In one embodiment of the disclosed anisotropic polymer film, at least one binding group is a complementary group.

The groups B providing solubility of the heterocyclic molecular system in water or water miscible solvents may be selected from the list comprising COO⁻, SO₃⁻, HPO₃⁻ and PO₃²⁻ and any combination thereof. The groups B providing solubility of the heterocyclic molecular system in organic solvents may be selected from the list comprising CONHCONH₂, CONR2R3, SO₂NR2R3, CO₂R2, R2 or any combination thereof, wherein R2 and R3 are independently selected from hydrogen, alkyl, and aryl, as defined hereinabove.

In another embodiment of the disclosed anisotropic polymer film, at least one kind of said heterocyclic molecular systems is partially or completely conjugated. In still another embodiment of the disclosed anisotropic polymer film, said heterocyclic molecular system comprises heteroatoms, which serve as binding sites and are selected from the list comprising nitrogen, oxygen, sulfur, and any combination thereof. In another embodiment of the disclosed anisotropic polymer film, at least one kind of said heterocyclic molecular systems is predominantly flat. In yet another embodiment of the anisotropic polymer film, at least one kind of said heterocyclic molecular systems has a form selected from the list comprising disk, plate, lamella, ribbon or any combination thereof. In one embodiment of the disclosed anisotropic polymer film, at least one kind of said heterocyclic molecular systems possesses lyophilic properties. In another embodiment of the disclosed anisotropic polymer film, at least one kind of said heterocyclic molecular systems possesses lyophobic properties. In another embodiment of the disclosed anisotropic polymer film at least one kind of said heterocyclic molecular systems has no less than two binding groups. The heterocyclic molecular system preferably has an axis of symmetry of order k (Cₖ) directed perpendicularly with respect to the plane of heterocyclic molecular system, where k is a number no less than 3.

Examples of predominantly planar heterocyclic molecular systems with pyrazine or/and imidazole cycles having general structural formulas corresponding to structures 1-5 are shown in the Table 1.

TABLE 1
Examples of predominantly planar heterocyclic molecular
systems with pyrazine or/and imidazole fragments

| | |
|---|---|
| 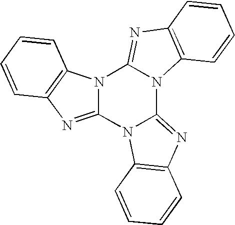 | (1) |
| 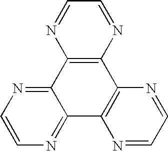 | (2) |
| 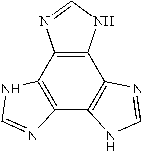 | (3) |
| 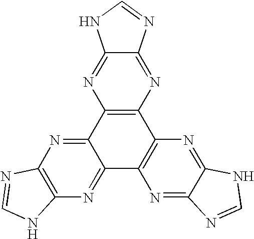 | (4) |
| 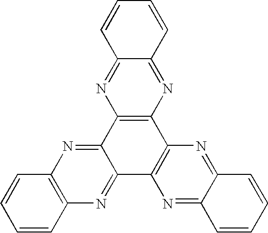 | (5) |

In another embodiment of the organic compound, the heterocyclic molecular system is an oligomer comprising imidazole and/or benzimidazole cycles, which are capable of forming hydrogen bonds. Examples of such predominantly planar heterocyclic molecular systems having general structural formulas corresponding to structures 6-15 are shown in the Table 2, wherein n is a number from 1 to 20.

TABLE 2
Examples of predominantly planar heterocyclic molecular
systems containing oligomer comprising imidazole
or/and benzimidazole cycles

| | |
|---|---|
| 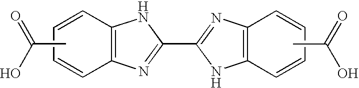 | (6) |
| 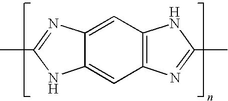 | (7) |
| 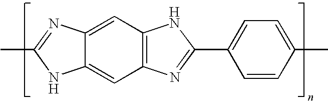 | (8) |
| 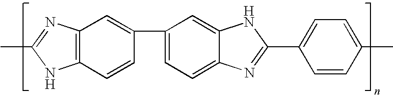 | (9) |
| 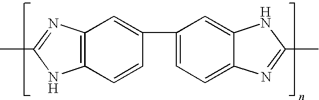 | (10) |
| 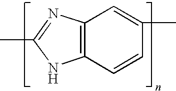 | (11) |
| 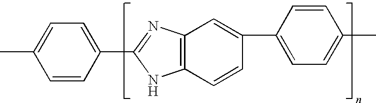 | (12) |
| 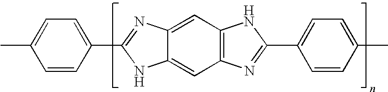 | (13) |
| 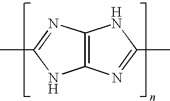 | (14) |
| 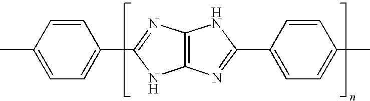 | (15) |

In still another embodiment of the organic compound, the heterocyclic molecular system is tetrapirolic macrocycle. Examples of such predominantly planar heterocyclic molecular systems having a general structural formulas corresponding to structures 16-21 are shown in the Table 3, where the M denotes atom of metal or denotes two protons:

TABLE 3
Examples of planar heterocyclic molecular systems
comprising tetrapirolic macrocycles

| | |
|---|---|
| 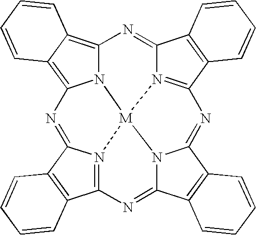 | (16) |
| 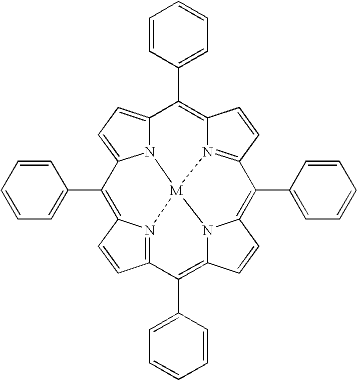 | (17) |
| 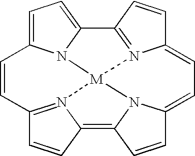 | (18) |
| 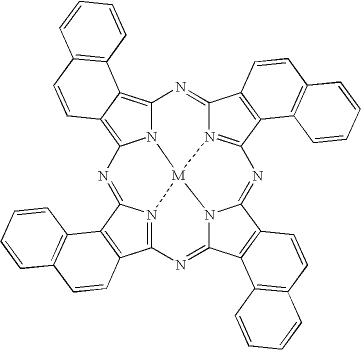 | (19) |
| 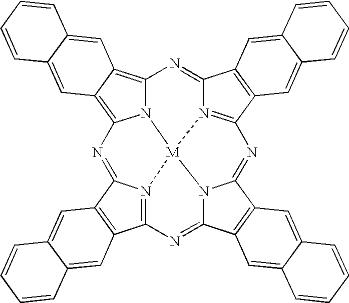 | (20) |
| 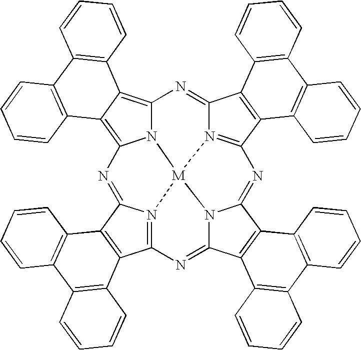 | (21) |

In yet another embodiment of the organic compound, the heterocyclic molecular system comprises rylene fragments. Examples of such predominantly planar heterocyclic molecular systems having general structural formulas corresponding to structures 22-39 are shown in the Table 4:

TABLE 4
Examples of heterocyclic molecular systems
comprising rylene fragments

| | |
|---|---|
| 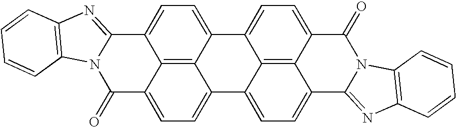 | (22) |
| 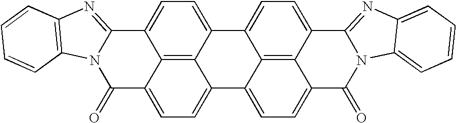 | (23) |
| 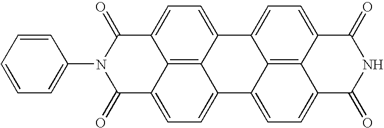 | (24) |
| 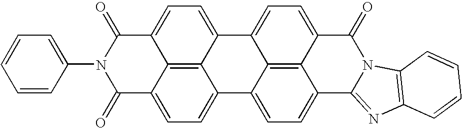 | (25) |
| 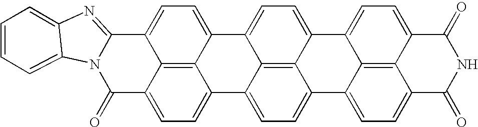 | (26) |
| 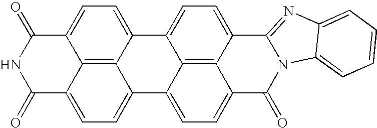 | (27) |
| 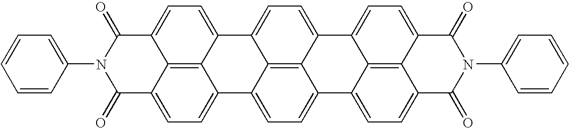 | (28) |
| 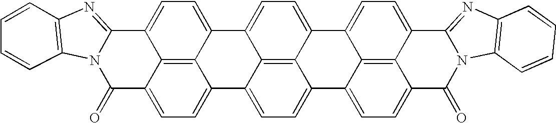 | (29) |
| 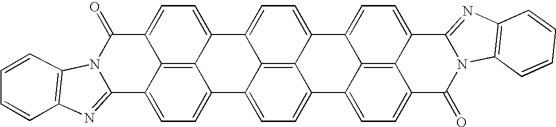 | (30) |
| 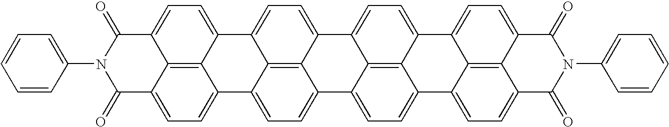 | (31) |
| 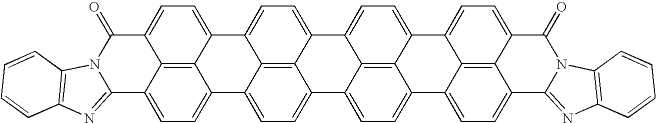 | (32) |
| 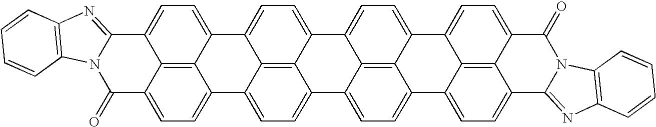 | (33) |
| 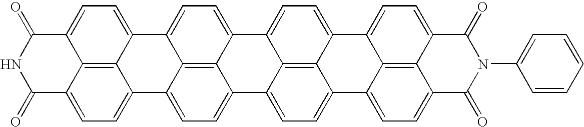 | (34) |
| 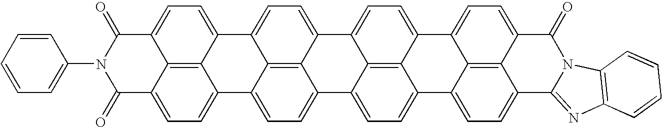 | (35) |
| 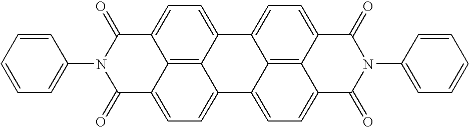 | (36) |
| 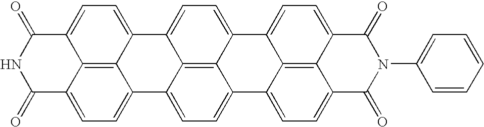 | (37) |
| 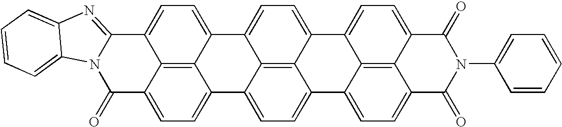 | (38) |
| 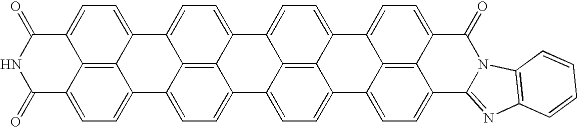 | (39) |

In one preferred embodiment of the disclosed anisotropic polymer film, the organic compound is an oligophenyl derivative. Examples of oligophenyl derivatives having general structural formulas corresponding to structures 40-46 are given in Table 5.

TABLE 5
Examples of the oligophenyl derivatives

| | |
|---|---|
| 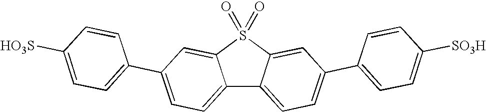 | (40) |
| 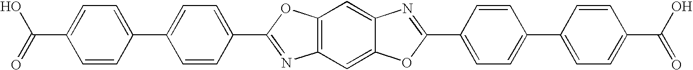 | (41) |
| 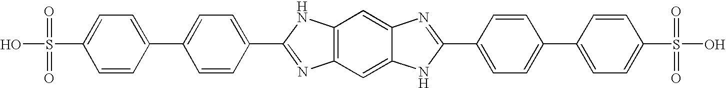 | (42) |
| 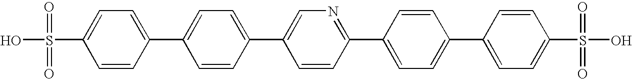 | (43) |
| 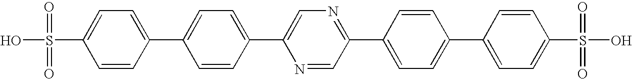 | (44) |
| 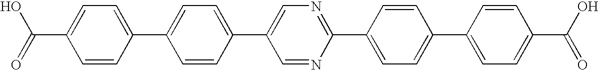 | (45) |
| 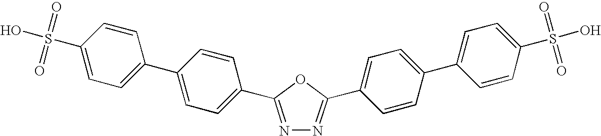 | (46) |

In one embodiment of present invention, the anisotropic polymer film further comprises anisometric particles formed by strong noncovalent chemical bonds formed between heterocyclic molecular systems via the binding groups. In another embodiment of the anisotropic polymer film, the anisometric particles contain binding groups capable of forming labile noncovalent chemical bonds. In still another embodiment of the anisotropic polymer film, the binding groups ensure the formation of flat anisometric particles. In yet another embodiment of the anisotropic polymer film, the flat anisometric particles have the form selected from the list comprising disk, plate, lamella, ribbon or any combination thereof. In one embodiment of the anisotropic polymer film, the anisometric particles have the form selected from the list comprising chain, needle, column or any combination thereof. In another embodiment of the anisotropic polymer film, the anisometric particles are bound with the binding sites, which form donor-acceptor bonds of Dp-Ap type, where Dp-donor of proton and Ap-acceptor of proton. In yet another embodiment of the invention, the anisotropic polymer film further comprises a three-dimensional network structure formed by strong and weak noncovalent chemical bonds between the anisometric particles via the binding groups, said strong noncovalent chemical bond type preferably being selected from the list comprising coordination bond, ionic bond, or ion-dipole interaction, multiple H-bond, interaction via heteroatoms, and any combination thereof, and said weak noncovalent chemical bond type preferably being selected from the list comprising single H-bond, dipole-dipole interaction, cation-π interaction, van der Weals interaction, π-π interaction, and any combination thereof. In one embodiment of the invention, the anisotropic polymer film further comprises'column-like supramolecules formed via π-π interaction between the adjacent heterocyclic molecular systems, wherein said supramolecules are bound with the binding sites. In another embodiment of the invention, the anisotropic polymer film further comprises column-like supramolecules formed via π-π interaction between the adjacent heterocyclic molecular systems, wherein said supramolecules are bound with the binding groups. In one embodiment of the anisotropic polymer film, the column-like supramolecules are aligned in the substrate plane. In another embodiment of the anisotropic polymer film, longitudinal axes of the column-like supramolecules are directed perpendicularly in relation to the substrate plane. In still another embodiment of the disclosed invention the anisotropic polymer film further comprises a sticker selected from the list comprising ions of hydrogen, bases, alkali metals, transition metals, platinum-group metals, and rare-earth metals, and preferably the stickers are selected from the list comprising NH₄⁺, Na⁺, K⁺, Li⁺, Ba²⁺, Ca²⁺, Mg²⁺, Sr²⁺, Zn²⁺, Zr⁴⁺, Ce⁴⁺, Y³⁺, Yb³⁺, Gd³⁺, Er³⁺, Co²⁺, Co³⁺, Fe²⁺, Fe³⁺, Cu²⁺ and mixtures thereof. In one embodiment of the disclosed anisotropic polymer film, said anisotropic layer possesses anisotropic electric conductivity. In another embodiment, the anisotropic polymer film possesses anisotropic mechanical properties. In still another embodiment of the disclosed anisotropic polymer film, said anisotropic layer possesses anisotropic magnetic susceptibility. In yet another embodiment of the disclosed anisotropic polymer film, the anisotropic layer is generally a biaxial retardation layer transparent in the visible spectral range (approximately from 390 nm to 770 nm). In still another embodiment of the disclosed anisotropic polymer film, the anisotropic layer is generally a uniaxial retardation layer transparent in the visible spectral range. In one embodiment of the disclosed anisotropic polymer film, said anisotropic layer exhibits anisotropic optical absorption in the visible spectral range. In another embodiment of the disclosed anisotropic polymer film, said anisotropic layer is generally a biaxial retardation layer transparent in the Near-UV spectral ranges (approximately from 300 nm to 390 nm). In yet another embodiment of the disclosed anisotropic polymer film, said anisotropic layer is generally a uniaxial retardation layer transparent in the Near-UV spectral ranges. In still another embodiment, the anisotropic layer exhibits anisotropic optical absorption in the UV spectral range. In another embodiment, said anisotropic layer is generally a biaxial retardation layer transparent in the near IR spectral range. In one embodiment of the disclosed anisotropic polymer film said anisotropic layer exhibits anisotropic optical absorption in the near IR spectral range. In one embodiment of the disclosed anisotropic polymer film, the substrate is made of a polymer. In another embodiment of the anisotropic polymer film, the substrate is made of a glass. In still another embodiment, the disclosed anisotropic polymer film has a substrate transparent for electromagnetic radiation in the visible spectral range. In one embodiment of the disclosed anisotropic polymer film, the substrate is transparent for electromagnetic radiation in the Near-UV spectral ranges. In another embodiment of the disclosed anisotropic polymer film the substrate is transparent for electromagnetic radiation in the near IR spectral range. In another embodiment of the anisotropic polymer film, the anisotropic layer is applied onto the front surface of the substrate, and the rear surface of the substrate is covered with an antireflection or antiglare coating. In still another embodiment, the anisotropic layer is applied onto the front surface of the substrate, and a reflective layer is applied onto the rear surface of the substrate. In yet another embodiment of the anisotropic polymer film, the substrate is a specular or diffusive reflector. In another embodiment of the anisotropic polymer film, the substrate is a reflective polarizer. In one embodiment of the disclosed invention, the anisotropic polymer film further comprises a planarization layer applied onto the front surface of the substrate.

In one embodiment of the anisotropic polymer film according to the present invention, lyophobic heterocyclic molecular systems are linked via coordination bonds. Here, a doubly charged zinc cation occurs at the center of an octahedron representing square bipyramids sharing bases. The corners of the square base attach oxygen ions of the binding groups belonging to the neighboring heterocyclic molecular systems, while the vertices of pyramids can attach oxygen atoms of water, which is a solvent of the reaction mixture in the given embodiment. The presence of such heterocyclic molecular systems linked by coordination bonds in a polymer film imparts anisotropic physical properties to this film.

A detailed description of one possible embodiment of the method of the present invention involving the Cascade Polymerization process is given below.

In the first step, a reaction mixture is prepared using three components dissolved in an appropriate solvent: (1) heterocyclic molecular systems (Hetᵢ), (2) St-type molecules (stickers), and (3) Sp-type molecules (stoppers). Said heterocyclic molecular systems (Hetᵢ) comprise three or more molecular binding groups A and molecular groups B ensuring solubility of the heterocyclic molecular systems. The binding groups form chemical bonds of various types with binding groups of adjacent heterocyclic molecular systems and with stickers (St), comprising coordination bonds, ionic bonds, H-bonds, and π-π interactions, which render the heterocyclic molecular systems capable of polymerization. Each of these chemical bonds is characterized by certain strength, which is determined by the binding energy. The coordination and ionic bonds belong to the so-called strong chemical bonds with binding energies on the order of 450 kJ/mole. Single H-bonds possessing binding energies (typically within 10-40 kJ/mole) much smaller than those of the coordination and ionic bonds, are classified as weak bonds. H-bonds, having relative lower strengths with binding energies 5-10 times smaller than those of the coordination and ionic bonds, occupy an intermediate position between these bonds and the van der Waals interactions. The latter interactions hold molecules together in the solid and liquid phases. However, multiple H-bonds involving 5-10 single H-bonds should be considered as strong.

The number of stoppers in the reaction mixture is selected so as to ensure a preset degree of polymerization (n). In the case of heterocyclic molecular systems having two binding groups which are located opposite each other, the polymerization yields linear chains bonded from both sides by stoppers. The role of binding groups can be played, for example, by two carboxy groups COOH in one heterocyclic molecular system (Hetᵢ) and two NHR groups in the other heterocyclic molecular system (Het₂), where radical R is selected from the list comprising hydrogen, alkyl and aryl. Noncovalent chemical bonds between the binding groups can exhibit rupture and recovery. For this reason, the polymer chains occur in the state of dynamic equilibrium with the reaction mixture, whereby these chains can be broken and then re-assembled. Thus, the linear polymer chain occurs in equilibrium with the reaction mixture due to the lability of binding groups. The process of bond rupture and recovery involves weak contacts (H-bonds), while strong bonds (coordination, ionic, and multiple H-bonds) favour the formation of strong anisometric particles (kinetic particles of the reaction mixture). Such polymer structures will be called labile. The binding groups ensure the formation of flat anisometric particles (polymer particles), provided that the given heterocyclic molecular system has two binding groups and the sticker has three binding groups. An example of such a sticker is offered by a benzene molecule with three carboxy groups (trimesic acid, TMA):

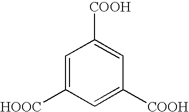

The heterocyclic molecular system can be represented, for example, by bipyridyl (Bipy). The binding groups of Bipy form labile noncovalent chemical bonds in the plane of the heterocyclic molecular systems, which can exhibit rupture and recovery.

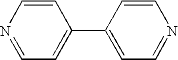

The polymerization of such molecules results in the formation of a labile flat anisometric particle (polymer particle).

In one possible embodiment of the disclosed invention, identical binding groups belonging to different heterocyclic molecular systems form noncovalent chemical bonds between these systems. Such binding groups are called self-binding or complementary.

The degree of polymerization is selected so as to provide that, on the one hand, the reaction mixture would possess a sufficiently high viscosity for convenient application onto the substrate and, on the other hand, the kinetic particles (linear chains, flat structures) would have dimensions making possible their orientation on the subsequent steps of the technological process.

The function of stickers can be performed by metals (such as alkali metals, transition metals, platinum-group metals, and rare-earth metals) capable of forming coordination bonds with binding groups. The coordination bond is a kind of chemical bonds typical of coordination compounds. This kind of bonds is characterized by the electron density transfer from an occupied orbital of a sticker molecule (donor) to a vacant orbital of the central atom (acceptor) with the formation of a common bonding molecular orbital.

Ionic bonds between the binding groups can be formed as a result of the Coulomb attraction of ions with opposite charges. The well-known example of a compound with ionic bonds is offered by sodium chloride, where sodium cation (Na⁺) represents a sodium atom losing one electron and acquiring a stable electron configuration of neon, and chloride ion (Cl⁻) is a chlorine atom attaching one electron and acquiring a stable electron configuration of argon. The chemical formula (NaCl) of this compound is determined by the stability of these ions and the condition of electroneutrality of the molecule. Metals of the first group of the periodic table form singly charged positive ions (in other words, possess the ion valence +1), metals of the second group form doubly charged ions (with the ion valence +2), and so on. Similarly, halogens (elements of the seventh group) attach one electron and form singly charged negative ions (with the ion valence −1), oxygen and its analogs can accept two electrons and form doubly charged negative ions with an electron structure of inert gases (with the ion valence −2), and so on. The compositions of ionic salts are determined by the ion valences of their cations and anions, which must obey the condition of electroneutrality of the molecule. The Coulomb forces between ions (e.g., Na⁺ and Cl⁻) result in that each ion attracts the adjacent counterions, thus creating an ordered environment. The Coulomb attraction forces between oppositely charged ions are also called the valence forces. In sodium chloride, where each sodium ion is surrounded by six nearest-neighbor chlorine ions (i.e., has a coordination number of six), the ion valence +1 is divided between these neighbors, so that each chemical bond between sodium and the adjacent chlorine can be considered as the ionic bond with a strength of ⅙. By the same token, the negative valence −1 of each chlorine atom is distributed between six ionic bonds (each with strength of ⅙) with nearest-neighbor sodium ions. According to the valence rule, which is of key importance in inorganic chemistry, the sum of ion valences directed to each negative ion must be exactly (or approximately) equal to the ion valence of this ion.

The binding groups can be also linked by H-bonds. By H-bond is implied the interaction between a hydrogen-containing group (AH) of one molecule (RAH) and an atom (B) of another molecule (BR′). As a result of this interaction, a stable complex (RAH . . . BR′) with an intermolecular H-bond (H . . . B) is formed, in which hydrogen atom plays the role of a bridge that links RA and BR′ fragments. Since atom H in molecule RAH is positively charged, it is most strongly attracted to the sites of molecule BR′ with most negative values of the potential. Such sites usually occur in the region of localization of the unshared electron pair (UEP) of atom B. For this reason, molecule BR′ frequently becomes oriented relative to molecule RAH so that the UEP axis approximately coincides with the direction of the A—H bond. By virtue of the Pauli principle, electrons with the same spins “avoid” one another, which leads to a decrease in the electron density in the space between nuclei of the approaching atoms (H and B) in the RAH . . . BR′ complex. As a result, H⁺ and B⁺ nuclei are screened by electrons to a lower extent than analogous nuclei in the case of free atoms. Since these nuclei bear charges of the same sign, they exhibit strong repulsion on approaching each other. Simultaneously, the electron shell of each molecule (RAH and BR′) exhibits deformation in the electrostatic field of another molecule. This deformation gives rise to the induced dipole moment in each molecule, (P_{RAH} and P_{BR′}, respectively). Evidently, the stronger the H-bond in the RAH . . . BR′ complex, the more pronounced the electron density redistribution between the interacting molecules RAH and BR′, and the greater the induced dipole moments in the molecules.

The higher the potential at the hydrogen atom H, the stronger the H-bond formed by the AH group. For this reason, the strongest H-bonds are formed in cases where atom A and substituent groups in molecule RAH are most electronegative. The ability of atom B to be a proton acceptor during the formation of an H-bond is also determined mostly by the electrostatic potential at this atom in molecule BR′. The strongest H-bonds with a proton donor are formed by oxygen (O) atoms in oxides of amines, arsines, phosphines, and sulfides, and by nitrogen (N) atoms in amines. A reliable approach to detecting H-bonds is offered by spectroscopic methods (IR spectrophotometry, Raman spectroscopy). The spectral characteristics of AH groups involved in H-bonds are significantly different from those observed in the absence of such bonds. In addition, if the results of structural investigations indicate that the distances between B and H atoms are smaller than the sum of their van der Waals radii, it is commonly accepted that the H-bond formation is reliably established. Thus, predominant orientation (an isotropic distribution) of H-bonds in the polymer film under consideration can be revealed by investigations of the absorption of polarized IR radiation in the film.

It is highly probable that the dipole moments P_{RAH} and P_{BR′} induced as a result of the deformation of electron shells in the corresponding fragments are oriented along the H-bond and have opposite directions. It can be expected that the electron density in the shells deformed in this way will be higher than that in the case of remote molecules RAH and BR′. For this reason, the specific electron density at the oxygen atom in an H-bond of the O . . . H type is apparently higher than in the conjugated carbon systems. In the H-bond of this type, the total charge on oxygen must be equal or close to the charge on proton.

Linked by coordination and/or ionic (valence) interactions, binding groups form stable noncovalent chemical bonds with each other. These bonds are directed either from one ion to another (in the case of ionic interactions) or from sticker (donor) to the central atom (acceptor) for the coordination bonds). For this reason, the local contributions of such oriented binding groups to the physical properties of a polymer film such as electric conductivity, mechanical strength, refractive index, and magnetic susceptibility will also be anisotropic. Therefore, the anisotropic orientation imparted to all or the major part of binding groups in the reaction mixture applied onto a substrate in the subsequent steps of the process will render the obtained film anisotropic.

The strong (coordination, multiple H-bond, and ionic) chemical bonds between the binding groups lead to the formation of stable anisometric particles (kinetic particles) in the reaction mixture. These anisometric particles can have various shapes, comprising columnar (when disk-like molecules are stacked), ribbon (when the molecules are aligned in one direction and attached to each other by more than one chemical bond), and lamellar (when the molecules form a flat system). The anisometric particles must be sufficiently large in order to provide for their effective orientation by hydrodynamic flow in the course of application of the reaction mixture onto a substrate by means of extrusion. Single H-bonds and other weak contacts can also be formed between anisometric particles and between these particles and solvent molecules. The saturation of a reaction mixture by the H-bonds and weak bonds of other types can lead to the gel formation. Such a reaction gel mixture can be used for obtaining thin (50 to 80-nm-thick) anisotropic polymer films.

The reaction mixtures can be prepared in water, dimethylformamide (DMF), and other solvents.

In the second step, the reaction mixture is applied onto a substrate. In one embodiment of the disclosed method, the reaction mixture is applied by means of extrusion with simultaneous orientation of anisometric particles. The degree of orientation depends on the hydrodynamic flow velocity, temperature, degree of polymerization, and some other technological parameters, which have to be selected so as to provide for the preferred orientation of binding groups (and, hence, anisometric particles) in the applied polymer film. An additional orienting action can be provided by irradiation of the applied solution with a polarized IR radiation. The binding groups are selected so as to provide that weak bonds (e.g., single hydrogen bonds) between the anisometric particles would be destroyed in the course of solution extrusion via the die and then restored on the substrate. At the same time, the strong bonds (coordination, ionic, and multiple H-bonds) are not broken during the extrusion, which ensures the stability of anisometric particles. This behaviour of strong and weak bonds, on the one hand, leads to a decrease in the reaction mixture viscosity during the application (which facilitates this process) and, on the other hand, retains the anisometric particles and makes possible their orientation by the hydrodynamic flow on the substrate. After the application, the weak bonds (in particular, single H-bonds) between ordered anisometric particles are restored. Moreover, these restored bonds also acquire an anisotropic orientation that contributes to the anisotropy of physical characteristics of the obtained polymer layer. At the same time, the restoration of weak bonds (including H-bonds) in the applied layer imparts additional elasticity to this layer, which increases the stability of the established order of anisometric particles after termination of the shear action of the hydrodynamic flow and reduces the disordering action of the substrate surface on the anisotropic film in the course of the subsequent step (drying), which involves polymerization of the applied layer.

The final step in the disclosed process is drying of the applied layer, which can be performed in air at room temperature.

An additional step can also be introduced in the disclosed process, which consists in a special treatment of the dry layer that renders the obtained anisotropic polymer film insoluble in water. This additional treatment depends on the type of binding groups. In the case of SO₃H groups, the film is treated with a solution of barium salts (e.g., BaCl₂), while the films containing sulfonic and carboxy groups are treated with a mixture of BaCl₂ and HCl. It should be noted that the additional treatment leads to the rupture of a certain fraction of H-bonds and, hence, to a decrease in the degree of anisotropy of the polymer film. However, the relative fraction of ruptured H-bonds in their total amount can be controlled. The subsequent process of solvent removal (drying) is performed under mild conditions at room temperature for a time period up to approximately 1 hour, or by heating in the temperature range from approximately 20 to 60° C. for the sake of time saving, and at a relative humidity of 40-70%.

In one embodiment of the disclosed invention, the method further comprises the step of application of an external alignment action upon the deposited liquid layer in order to provide predominant alignment of said binding groups. In another embodiment of the disclosed method, the deposition and alignment steps are carried out simultaneously. In one embodiment of the disclosed method, the molecular binding group A is anisotropically polarizable. In another embodiment of the disclosed method, at least one of the binding groups is an acid binding group, and the acid binding groups are preferably selected from the list comprising COO⁻, SO₃⁻, HPO₃⁻, PO₃²⁻, and any combination thereof. In still another embodiment of the disclosed method, at least one of the binding groups is a basic binding group and the basic binding groups are preferably selected from the list comprising CONHCONH₂, NHR, NR₂, CONH₂, and any combination thereof, where radical R is selected from the list comprising hydrogen, alkyl and aryl, as defined below. In yet another embodiment of the disclosed method, the alkyl group is selected from the list comprising methyl, ethyl, propyl, i-propyl, butyl, i-butyl, s-butyl and t-butyl groups, and the aryl group is selected from the list comprising phenyl, benzyl and naphthyl groups. Preferred alkyl groups have general formula CH₃(CH₂)ₙ— or Cₙ—H₂ₙ₊₁—, where n is equal to from 1 to 23.

In one embodiment of the disclosed method, at least one binding group is a complementary group.

The groups B providing solubility of the heterocyclic molecular system in water or water miscible solvents may be selected from the list comprising COO⁻, SO₃⁻, HPO₃⁻ and PO₃²⁻ and any combination thereof. The groups B providing solubility of the heterocyclic molecular system in organic solvents may be selected from the list comprising CONHCONH₂, CONR2R3, SO₂NR2R3, CO₂R2, R2 or any combination thereof, wherein R2 and R3 are selected from hydrogen, alkyl, and aryl, as defined hereinabove.

In another embodiment of the disclosed method, at least one kind of said heterocyclic molecular systems is partially or completely conjugated. In still another embodiment of the disclosed method, said heterocyclic molecular system comprises heteroatoms, which serve as binding sites and are selected from the list comprising nitrogen, oxygen, sulfur, and any combination thereof. In another embodiment of the disclosed method, at least one kind of said heterocyclic molecular systems is predominantly flat. In yet another embodiment of the method, at least one kind of said heterocyclic molecular systems has a form selected from the list comprising disk, plate, lamella, ribbon or any combination thereof. In one embodiment of the disclosed method, at least one kind of said heterocyclic molecular systems possesses lyophilic properties. In another embodiment of the disclosed method, at least one kind of said heterocyclic molecular systems possesses lyophobic properties. In another embodiment of the disclosed method at least one kind of said heterocyclic molecular systems has no less than three binding groups. The heterocyclic molecular system preferably has an axis of symmetry of order k (Cₖ) directed perpendicularly with respect to the plane of heterocyclic molecular system, where k is a number no less than 3.

Examples of predominantly planar heterocyclic molecular systems with pyrazine or/and imidazole cycles having a general structural formulas corresponding to structures 1-5 are shown in the Table 1.

In another embodiment of the method, the heterocyclic molecular system is an oligomer comprising imidazole and/or benzimidazole cycles, which are capable of forming hydrogen bonds. Examples of such predominantly planar heterocyclic molecular systems having a general structural formulas corresponding to structures 6-12 are shown in the Table 2, wherein n is a number from 1 to 20. In still another embodiment of the method, the heterocyclic molecular system is tetrapirolic macrocycle. Examples of such predominantly planar heterocyclic molecular systems having a general structural formulas corresponding to structures 13-18 are shown in the Table 3, where the M denotes atom of metal or denotes two protons. In yet another embodiment of the method, the heterocyclic molecular system comprises rylene fragments. Examples of such predominantly planar heterocyclic molecular systems having a general, structural formulas corresponding to structures 19-36 are shown in the Table 4. In one preferred embodiment of the disclosed method, the organic compound is an oligophenyl derivative. Examples of the oligophenyl derivative having general structural formulas corresponding to structures 37-43 are given in Table 5.

In one embodiment of the method, the step (a) further comprises the formation of anisometric particles from organic molecules by means binding groups and sites via strong noncovalent chemical bonds. In another embodiment of the method, the anisometric particles contain binding groups capable of forming labile noncovalent chemical bonds. In still another embodiment of the method, the binding groups ensure the formation of flat anisometric particles. In yet another embodiment of the method, the flat anisometric particles have the form selected from the list comprising disk, plate, lamella, ribbon or any combination thereof. In one embodiment of the method, the anisometric particles have the form selected from the list comprising chain, needle, column or any combination thereof. In another embodiment of the method, the step (b) further comprises the binding of the anisometric particles via the binding sites, which form donor-acceptor bonds of Dp-Ap type, where Dp-donor of proton and Ap-acceptor of proton. In yet another embodiment of the method, the step (b) further comprises the formation of a three-dimensional network structure from anisometric particles by means of binding groups via strong and weak noncovalent chemical bonds, said strong noncovalent chemical bond type preferably being selected from the list comprising coordination bond, ionic bond, or ion-dipole interaction, multiple H-bond, interaction via heteroatoms, and any combination thereof, and said weak noncovalent chemical bond type preferably being selected from the list comprising single H-bond, dipole-dipole interaction, cation-π interaction, van der Weals interaction, π-π interaction, and any combination thereof. In one embodiment of the disclosed method, the step (a) further comprises the forming of column-like supramolecules formed via π-π interaction between the adjacent heterocyclic molecular systems, wherein said supramolecules are bound with the binding sites. In another embodiment of the disclosed method, the step (a) further comprises the forming of column-like supramolecules formed via π-π interaction between the adjacent heterocyclic molecular systems, wherein said supramolecules are bound with the binding groups. In one embodiment of the disclosed method, the column-like supramolecules are aligned in the substrate plane. In another embodiment of the disclosed method, longitudinal taxes of the column-like supramolecules are directed perpendicularly in relation to the substrate plane. In still another embodiment of the disclosed method, the stickers are selected from the list comprising ions of hydrogen, bases, alkali metals, transition metals, platinum-group metals, and rare-earth metals, and preferably the stickers are selected from the list comprising NH₄⁺, Na⁺, Li⁺, Ba²⁺, Ca²⁺, Mg²⁺, Sr²⁺, Zn²⁺, Zr⁴⁺, Ce⁴⁺, Y³⁺, Y³⁺, Gd³⁺, Er³⁺, Co²⁺, Co³⁺, Fe²⁺, Fe³⁺, Cu²⁺ and mixtures thereof. In one embodiment of the disclosed method, the alignment of the applied liquid layer is performed via mechanical action. This is achieved through directed mechanical motion of one or several alignment devices of various types, comprising a knife, a cylindrical wiper, a flat plate (oriented parallel to the applied layer surface or at an angle to this surface), a slot die, or any other alignment devices. In another embodiment of the disclosed method, the mechanical action on the deposited liquid layer is performed with the use of a slot die machine, extrusion machine, or molding machine. In still another embodiment of the method, the velocity of a hydrodynamic flow of the reaction mixture during extrusion provides a reduction of the viscosity of said mixture due to the rupture of weak bonds. In one embodiment of the disclosed method, the external alignment action on the applied layer is performed by means of directed mechanical translation of at least one aligning tool over the layer, wherein a distance from the surface of the substrate to the edge or the plane of the aligning tool is set so as to obtain the desired film thickness. In another embodiment, of the method the aligning tool is heated. In one embodiment of the disclosed method, concentrations of the heterocyclic molecular systems, binding groups, and stickers in the reaction mixture are chosen such as to provide thixotropy of the reaction mixture.

Increased mechanical strength and improved physical properties, in particular stability under the conditions of high temperatures and humidity, may be provided by treatment of the films with inorganic salts and water-soluble organic compounds capable of interacting with heterocyclic molecular systems and binding groups. A subsequent preferred additional stage according to the disclosed process is the treatment of the obtained solid layer of a noncovalent polymeric material with an aqueous solution of mineral salts in order to convert the layer into an insoluble form. For this purpose, it is possible to use, for example, a solution of barium chloride (BaCl₂) with a concentration in the range from 5 to 30%, the optimum interval being 10-20%. During this treatment, Ba²⁺ ions are replaced with NH⁴⁺ ions with the formation of insoluble organic barium sulfates. Unreacted barium sulfate, which can partially penetrate into pores and structural defects of the film, is subsequently removed by washing in water. Then, the film is preferably dried in air at room temperature or at an elevated temperature in the range from 20 to 70° C. for up to about 20 min, depending on the temperature. The resulting anisotropic polymer films possess higher stability with respect to environmental factors, improved mechanical properties, and better optical characteristics as compared to those of untreated films.

Yet another embodiment of the present invention provides a method for obtaining said films, which further comprises an additional treatment of the solid layer in order to ensure insolubility of the anisotropic polymer film. In still another embodiment, the present invention provides the method, wherein the coating is made using a gel. In yet another embodiment of the method, the coating is made using a viscous liquid phase. In one embodiment of the disclosed method the solvent is water. In one embodiment of the disclosed method the solvent is selected from the list comprising acetone, acetonitrile, benzene, dimethyl sulfoxide, dimethyl formamide, diethyl ether, methanol, nitrobenzene, nitromethane, pyridine, propylene carbonate, tetrahydrofuran, acetic acid, ethanol, methylene chloride, or a combination thereof. In one embodiment of the method, the amount of solvent provides a reaction mixture viscosity necessary for applying a liquid layer by means of a hydrodynamic flow. In still another embodiment of the method, the viscosity of the reaction mixture does not exceed 2 Pa·s. In another embodiment of the method, the anisometric particles have linear dimensions not smaller than one micron.

In order that the invention may be more readily understood, reference is made to the following Figures, which are intended to be illustrative of the invention, but are not intended to be limiting in scope.

FIG. 1 shows several possible embodiments of linear polymer chains for anisotropic films according to the present invention. In particular, chains can be formed as depicted in FIG. 1a from heterocyclic molecular systems of the same kind (Hetᵢ) having two binding groups located opposite each other via the formation of noncovalent chemical bonds between acid binding groups (A₁₁ and A₂₁), with two molecular stopper groups (Sp) terminating the growth of the polymer chain from both ends. In this embodiment, the degree of polymerization n depends on the dynamic equilibrium between the growing polymer chain and reaction mixture. The conditions of this equilibrium are determined by the temperature, concentrations of stoppers and heterocyclic molecular systems, pressure, and some other parameters of the reaction mixture. The degree of polymerization increases with decreasing concentration of stoppers. However, when the concentration of stoppers tends to zero or vanishes, other mechanisms restricting the degree of polymerization begin to operate. It is expedient to use reaction mixtures with a stopper concentration corresponding to the aforementioned dynamic equilibrium at a chain length of about one micron. In another embodiment (FIG. 1b), linear polymer chains are formed from heterocyclic molecular systems of two different kinds (Het₁ and Het₂), each has two acid binding groups located opposite each other and which are linked due to the interactions between these groups (A₁₁-A₁₂, A₂₂-A₁₁, and A₂₁-A₁₂). In the case of carboxy groups (—COOH), these contacts represent H-bonds between hydroxy group OH of one carboxy group and oxygen ion of another group. Another embodiment of the present invention employs linear polymer chains formed from heterocyclic molecular systems, which are linked due to the interaction of acid (A₁₁) and base (B₁₁) binding groups (FIG. 1c). In still another embodiment (FIG. 1d), linear polymer chains are formed due to the coordination bonds formed between stickers and acid binding groups. The role of stickers can be played, for example, by zinc cations (Zn²⁺), while acid binding groups can be represented by carboxy groups (COON). Yet another embodiment is offered by a linear polymer chain in which the coordination bonds are formed between a sticker (St) and acid (A₁₁) and base (B₁₁) binding groups.

FIG. 2 shows the structure of a flat anisometric particle (polymer particle) formed by stickers having three binding groups and heterocyclic molecular systems having two binding groups. Here, the possible sticker is TMA (comprising a benzene ring with three carboxy groups) and the possible heterocyclic molecular systems are bipyridyl (Bipy).

FIG. 3 schematically shows an organic compound comprising a flat disk-like heterocyclic molecular system and three binding groups. The positions of binding groups are indicated by oxygen (O^{δ}) bearing on a negative charge −δ. The heterocyclic molecular system has the third-order axis of symmetry directed perpendicularly to its plane. The given heterocyclic molecular systems contain nitrogen cations (N⁺) acting as heteroatoms. As a result, electric dipoles are formed in the plane of the heterocyclic molecular system, which impart lyophilic properties to the system. In the course of reaction mixture preparation, the heterocyclic molecular systems and binding groups form flat anisometric particles (kinetic particles) due to noncovalent chemical bonds between the binding groups of adjacent heterocyclic molecular systems. During application of the reaction mixture onto a substrate, a certain fraction of these flat anisometric particles are destroyed because of the rupture of weak noncovalent bonds. This destruction reduces viscosity of the reaction mixture and facilitates its orientation by the hydrodynamic flow. The planes of anisometric particles are oriented parallel to the substrate plane (xOy) due to the lyophilic properties of the heterocyclic molecular systems, which produces their affective homeotropic alignment. Then, the ruptured noncovalent chemical bonds in the anisometric particles are restored.

FIG. 4 schematically shows one possible structure of a flat anisometric particle (polymer particle). In this embodiment of the disclosed invention, noncovalent bonds are formed between cations (Ni⁺) of one heterocyclic molecular system and anions (O⁻) of the adjacent systems. If the binding groups are represented by carboxy groups, a different structure of flat anisometric particles is possible that combines the weak bonds of two types: (i) noncovalent bonds between heteroatoms and acid binding groups and (ii) H-bonds between two acid binding groups. The dimensions of anisometric particles preferably do not exceed one micron.

FIG. 5 illustrates the application of such anisometric particles onto a substrate, whereby flat polymer particles are deposited layer-by-layer and arbitrarily oriented in a plane of the substrate. FIG. 5 schematically shows the formation of anisotropic layer (1) on substrate (2) upon application of the reaction mixture containing anisometric particles (3). These anisometric particles comprise heterocyclic molecular systems (4) linked by noncovalent chemical bonds (5), which are partly ruptured in the course of deposition. Therefore, polymer films made according to disclosed method possess anisotropic physical properties. These properties are isotropic in the plane of the film and differ from the properties in the perpendicular direction. Accordingly, the polymer films disclosed in the present invention can possess anisotropic electric conductivity, anisotropic mechanical properties, anisotropic absorption of electromagnetic radiation, anisotropic magnetic susceptibility, and other anisotropic physical properties.

FIG. 6 schematically shows a molecular system comprising a disk-like heterocyclic molecular system with four binding groups, as indicated by oxygen (O^{δ}) bearing on a negative charge −δ. The given heterocyclic molecular system has the fourth-order axis of symmetry directed perpendicularly to its plane. In one embodiment, this molecular system possesses lyophilic properties. During preparation of the reaction mixture, the heterocyclic molecular systems form flat anisometric particles due to noncovalent bonds between binding groups of the adjacent systems. When the isotropic reaction mixture is applied onto a substrate, said anisometric particles are partly destroyed because of the rupture of weak noncovalent bonds. The planes of heterocyclic molecular systems are oriented parallel to the substrate plane (xOy) due to the lyophilic properties of the heterocyclic molecular systems, which produces their affective homeotropic alignment. Then, the flat isometric particles are restored due to noncovalent lateral interaction of the binding groups of heterocyclic molecular systems.

FIG. 7 shows a fragment of a flat anisometric particle. As can be seen, the binding groups are oriented predominantly in plane of the anisometric particle. In one possible embodiment of the present invention, these binding groups form H-bonds. Polymer films with such structures fabricated according to the disclosed invention possess anisotropic physical properties.

FIG. 8 schematically shows an organic compound containing disk-like heterocyclic molecular system and two binding groups, as indicated by oxygen (O^{δ}) bearing on a negative charge −δ. In one embodiment, these molecular systems are lyophobic and form anisometric particles having the configuration of column-like supramolecules (or molecular stacks) in the reaction mixture. When the reaction mixture is applied onto a substrate as depicted in FIG. 9, said supramolecules (6) are oriented with their planes perpendicular to the coating direction (Ox) and perpendicular to the plane of substrate (2). The binding groups of adjacent heterocyclic molecular systems form linear polymer chains (7), which are predominantly oriented in the Oy direction. In the embodiment of an anisotropic film according to the present invention depicted in FIG. 9, the binding groups form H-bonds aligned in the Oy direction.

FIG. 10 schematically shows an organic compound comprising a ribbon-like heterocyclic molecular system possessing lyophobic properties and two terminal binding groups, as indicated by oxygen bearing on a negative charge −δ. The longitudinal size of the heterocyclic molecular system (the distance between charged oxygens) exceeds the transverse size. In the reaction mixture, such molecular systems form column-like supramolecules (or molecular stacks) as depicted in FIG. 11. In one embodiment of the present invention, the length of supramolecules is about one micron. When the reaction mixture is applied onto substrate (2) by any of the adopted methods such as extrusion, said supramolecules (6) are oriented with their planes perpendicular to the coating direction (Ox) and perpendicular to the plane of substrate (2). FIG. 11 shows the case where linear polymer chains (7) are aligned in the Oy direction. In the given embodiment, these chains are formed due to H-bonds between binding groups belonging to the adjacent heterocyclic molecular systems of the neighboring supramolecules. These binding groups and, hence, H-bonds are predominantly oriented in the Oy direction. In one embodiment, the heterocyclic molecular systems contain carboxylic binding groups, and said H-bonds are formed between the hydroxy group OH of one carboxy group and oxygen ion of the adjacent group. Owing to the predominant orientation of H-bonds in the Oy direction, these bonds additionally contribute to the anisotropic physical properties of the given polymer film in this direction. The neighboring polymer chains situated on the substrate are linked due to the π-π interaction between the adjacent heterocyclic molecular systems involved in the neighboring supramolecules. Since this interaction is weak, the physical properties of the polymer film in the Ox direction will differ from those in the Oy and Oz directions. Accordingly, the polymer films disclosed in the present invention can possess isotropic physical properties (such as electric conductivity, mechanical strength, absorption of electromagnetic radiation, and magnetic susceptibility), which are significantly different along the three axes (Ox, Oy, and Oz).

In another embodiment of the present invention, the anisotropic polymer film is based on an organic compound containing a heterocyclic molecular system having two binding groups located opposite each other (see FIG. 12), which exhibits elongated ribbon-like configuration, possesses lyophilic properties, and has two terminal binding groups. In the reaction mixture, such molecular systems form isometric particles having the configuration of linear polymer chains with longitudinal binding groups, such as depicted in FIG. 13. When the reaction mixture is applied onto substrate (2), for example, by extrusion, said linear polymer chains (7) and, hence, binding groups are oriented along the coating direction (Ox). FIG. 13 schematically shows one embodiment, in which the polymer film consists of linear chains (7) with the binding groups capable of forming H-bonds. Owing to the lyophilic properties of heterocyclic molecular systems, their planes are oriented parallel to the substrate (xOy plane). The polymer film according to this embodiment is anisotropic and its physical properties are substantially different along the three axes (Ox, Oy, and Oz).

1. An anisotropic polymer film comprising:
a substrate, and
an anisotropic layer of noncovalently bound polymeric material,
wherein said anisotropic layer comprises a mixture of the general composition (I): 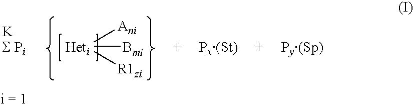
where Hetᵢ is a heterocyclic molecular system of the i-th kind,
K is the number of different kinds of heterocyclic molecular system in the mixture and is equal to 1, 2, 3, 4, 5 or 6,
i being an integer in the range from 1 to K,
P₁, P₂, . . . P_{K} are real numbers in the range from 0 to 1 and obey the condition: P₁+P₂+ . . . +P_{K}=1,
A is a molecular binding group, n being 2, 3, 4, 5, 6, 7 or 8,
B is a molecular group ensuring solubility of the heterocyclic molecular system, m being 0, 1, 2, 3, 4, 5, 6, 7, or 8,
R1 is a substituent group from the list comprising —CH₃, —C₂H₅, —NO₂, —CI, —Br, —F, —CF₃, —CN, —CNS, —OH, —OCH₃, —OC₂H₅, —OCOCH₃, —OCN, —SCN —NH₂, —NHCOCH₃, and —CONH₂, z being 0, 1, 2, 3 or 4,
St is a molecular group serving as a sticker,
Px is a real number in the range from 0 to 1,
Sp is a molecular group-serving as a stopper, and
Py is a real number in the range from 0 to 1;
wherein said binding groups are predominantly oriented so as to ensure anisotropic optical properties of the polymer film.

2. An anisotropic polymer film according to claim 1, wherein said anisotropic layer is produced by Cascade Polymerization process.

3. An anisotropic polymer film according to any of claims 1 or 2, wherein at least one of said binding groups is an acid binding group.

4. An anisotropic polymer film according to claim 3, wherein said at least one acid binding group is selected from the list comprising carboxylic (COO⁻), sulfonic (SO₃⁻), and phosphonic (HPO₃⁻ and PO₃²⁻) groups, and any combination thereof.

5. An anisotropic polymer film according to any of claims 1 to 4, wherein at least one of said binding groups is a basic binding group.

6. An anisotropic polymer film according to claim 5, wherein said at least one basic binding group is selected from the list comprising NHR, NR₂, CONHCONH₂, CONH₂ and any combination thereof, where radical R is selected from the list comprising hydrogen, alkyl and aryl.

7. An anisotropic polymer film according to claim 6, wherein the alkyl group has the general formula CH₃(CH₂)ₙ— or CₙH₂ₙ₊₁—, where n is equal to from 1 to 23.

8. An anisotropic polymer film according to claim 6, wherein the aryl group is selected from the list comprising, phenyl, benzyl and naphthyl groups.

9. An anisotropic polymer film according to claim 6 or 7, wherein the alkyl group is selected from the list comprising methyl, ethyl, propyl, i-propyl, butyl, i-butyl, s-butyl and t-butyl groups.

10. An anisotropic polymer film according to any of claims 1, 2, 3 or 5, wherein at least one said binding group is a complementary group.

11. An anisotropic polymer film according to any of claims 1 to 10, wherein the molecular binding group A is anisotropically polarizable.

12. An anisotropic polymer film according to any of claims 1 to 11 wherein the groups B provide solubility of the heterocyclic molecular system in water or water miscible solvents, and are independently selected from the list comprising COO⁻, SO₃⁻, HPO₃⁻ and PO₃²⁻ and any combination thereof.

13. An anisotropic polymer film according to any of claims 1 to 11 wherein the groups B provide solubility of the heterocyclic molecular system in organic solvents, and are independently selected from the list comprising CONHCONH₂, CONR2R3, SO₂NR2R3, CO₂R2, R2 or any combination thereof, wherein R2 and R3 are selected from hydrogen, alkyl, and aryl.

14. An anisotropic polymer film according to any of claims 1 to 13, wherein at least one kind of said heterocyclic molecular systems is partially or completely conjugated.

15. An anisotropic polymer film according to any of claims 1 to 14, wherein at least one kind of said heterocyclic molecular systems comprises heteroatoms, which serve as binding sites and are selected from the list comprising nitrogen, oxygen, sulfur, and any combination thereof.

16. An anisotropic polymer film according to any of claims 1 to 15, wherein at least one kind of said heterocyclic molecular systems is predominantly flat.

17. An anisotropic polymer film according to claim 16, wherein at least one kind of said heterocyclic molecular systems has the form selected from the list comprising disk, plate, lamella, ribbon or any combination thereof.

18. An anisotropic polymer film according to any of claims 1 to 17, wherein at least one kind of said heterocyclic molecular systems possesses lyophilic properties.

19. An anisotropic polymer film according to any of claims 1 to 17, wherein at least one kind of said heterocyclic molecular systems possesses lyophobic properties.

20. An anisotropic polymer film according to any of claims 1 to 19, wherein at least one kind of said heterocyclic molecular systems has no less than three binding groups.

21. An anisotropic polymer film according to any of claims 1 to 20, wherein the heterocyclic molecular system has an axis, of symmetry of order k (Cₖ) directed perpendicularly with respect to the plane of heterocyclic molecular system, where k is the number no less than 3.

22. An anisotropic polymer film according to any of claims 1 to 21, wherein the heterocyclic molecular system is predominantly planar and comprises pyrazine or/and imidazole cycles and has a general structural formula from the group comprising structures 1-5:

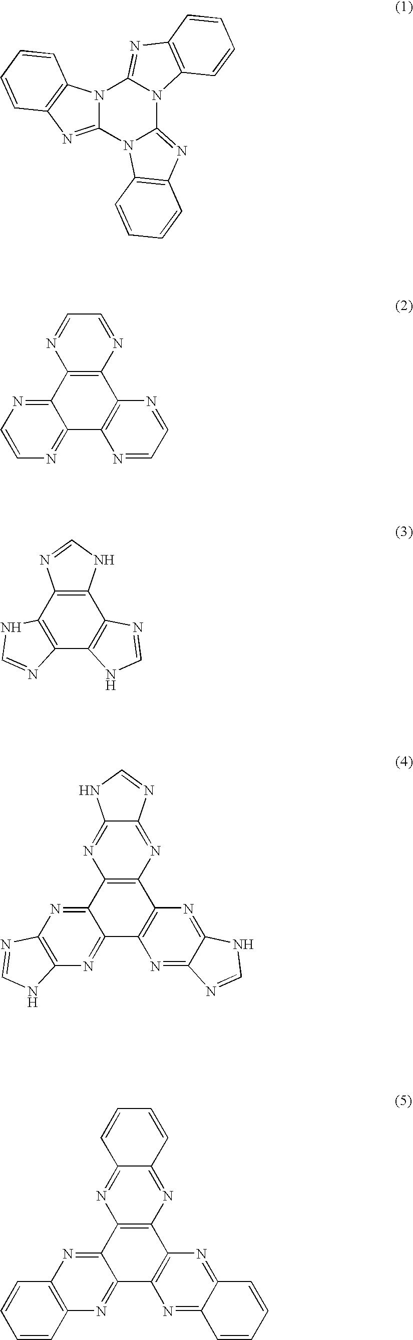

23. An anisotropic polymer film according to any of claims 1 to 20, wherein the heterocyclic molecular system is an oligomer comprising imidazole or/and benzimidazole cycles, which are capable of forming hydrogen bonds.

24. An anisotropic polymer film according to claim 23, wherein the heterocyclic molecular system is predominantly planar and comprises imidazole and/or benzimidazole cycles having a general structural formula corresponding to any one or more of structures 6-15, where the number n is in the range from 1 to 20:

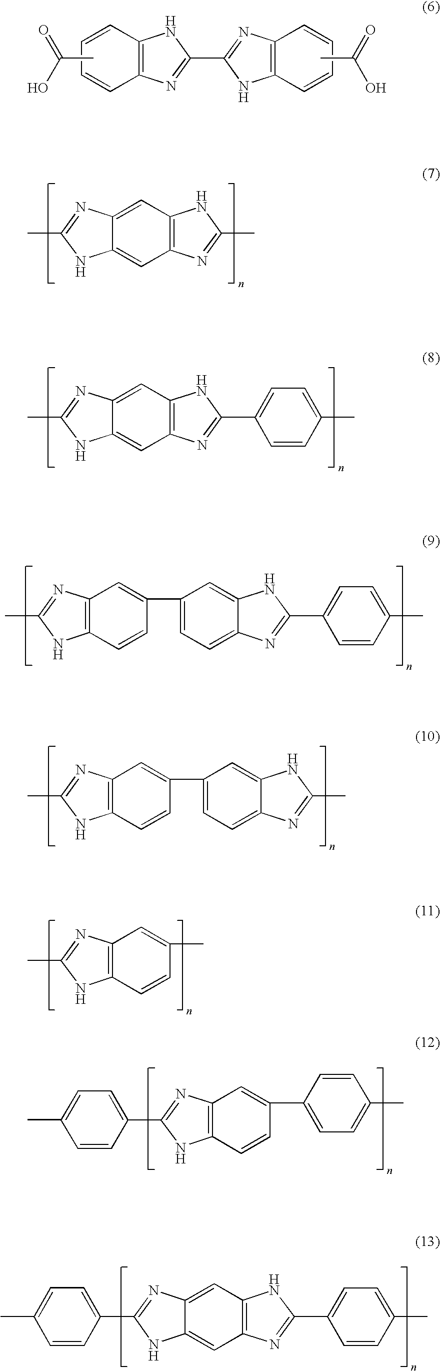

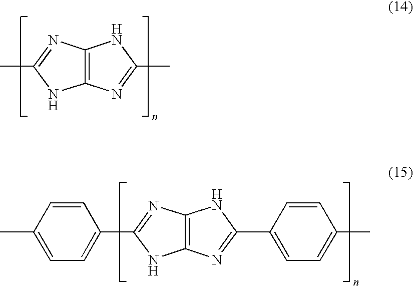

25. An anisotropic polymer film according to any of claims 1 to 20, wherein the heterocyclic molecular system is tetrapirolic macrocycle.

26. An anisotropic polymer film according to claim 25, wherein the heterocyclic molecular system is predominantly planar and comprises tetrapirolic macrocycles having a general structural formula corresponding to any one or more of structures 16-21, where the M denotes atom of metal or denotes two protons:

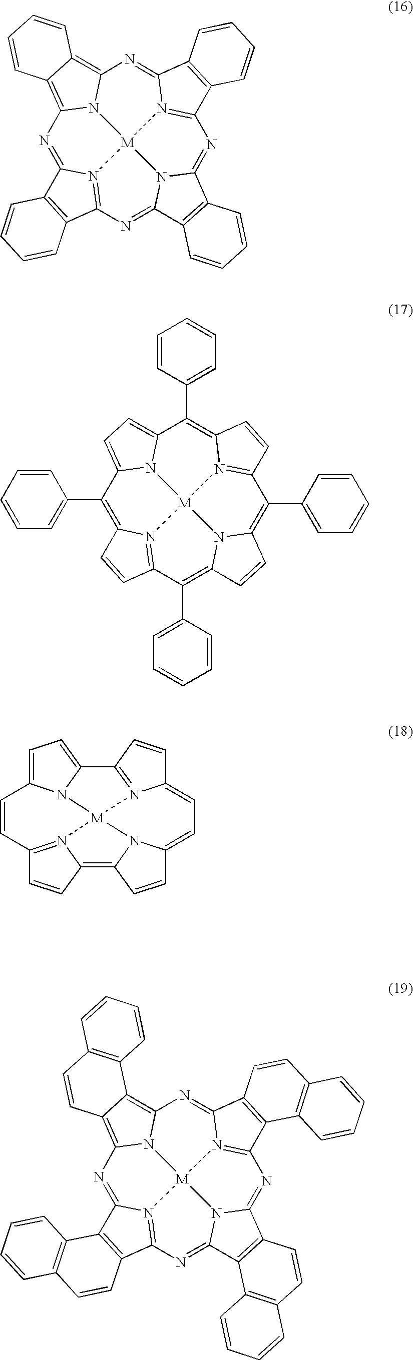

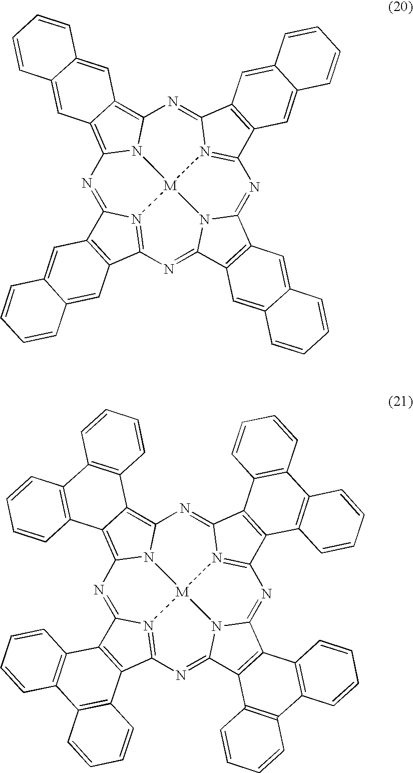

27. An anisotropic polymer film according to any of claims 1 to 20, wherein the heterocyclic molecular system comprises rylene fragments.

28. An anisotropic polymer film according to claim 27, wherein the heterocyclic molecular system is predominantly planar and comprises rylene fragments having a general structural formula corresponding to any one or more of structures 22-39, where the M denotes atom of metal or denotes two protons:

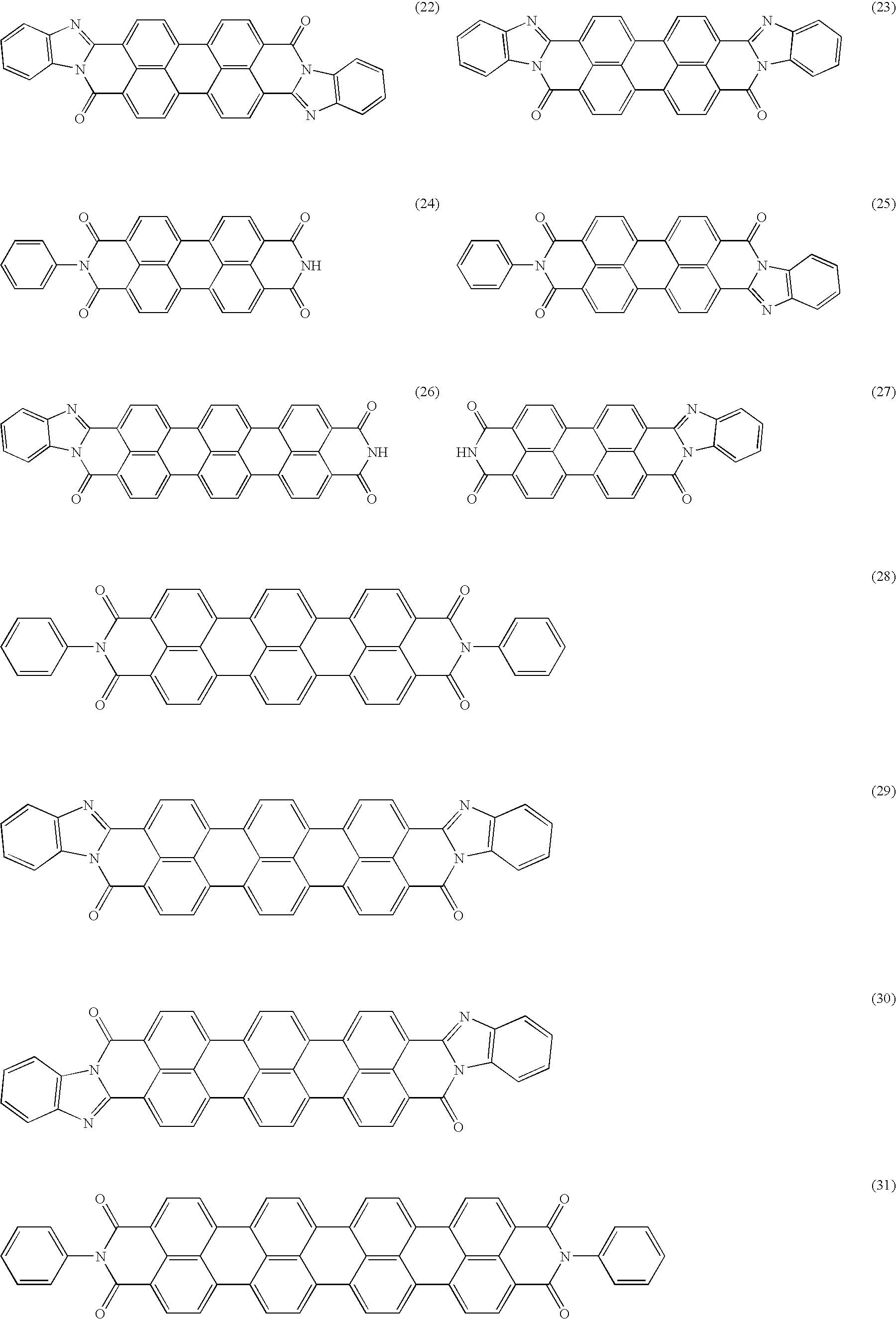

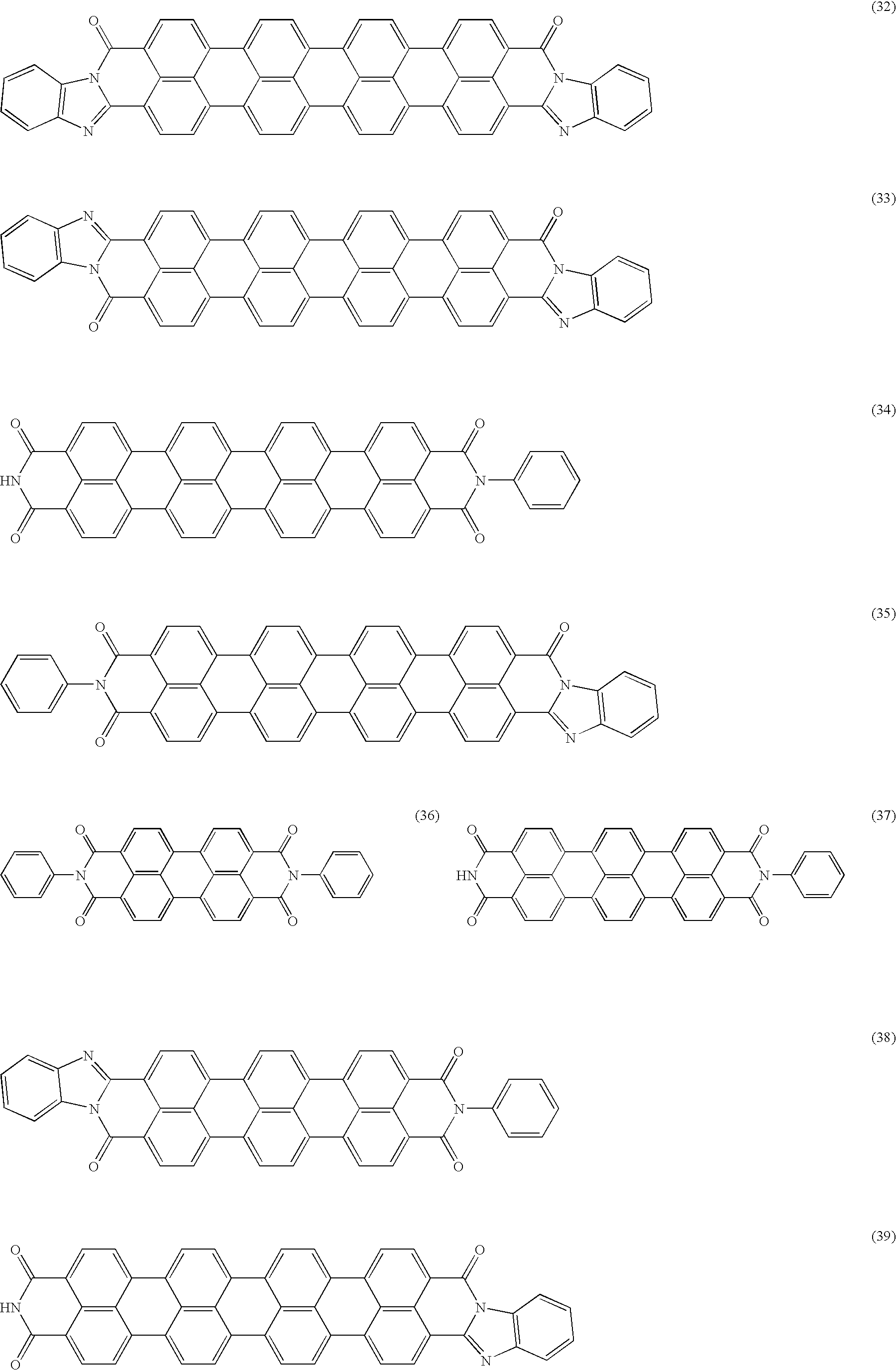

29. An anisotropic polymer film according to any of claims 1 to 20, wherein the organic compound is an oligophenyl derivative.

30. An anisotropic polymer film according to claim 29, wherein the oligophenyl derivative has a general structural formula corresponding to one of structures 40 to 46:

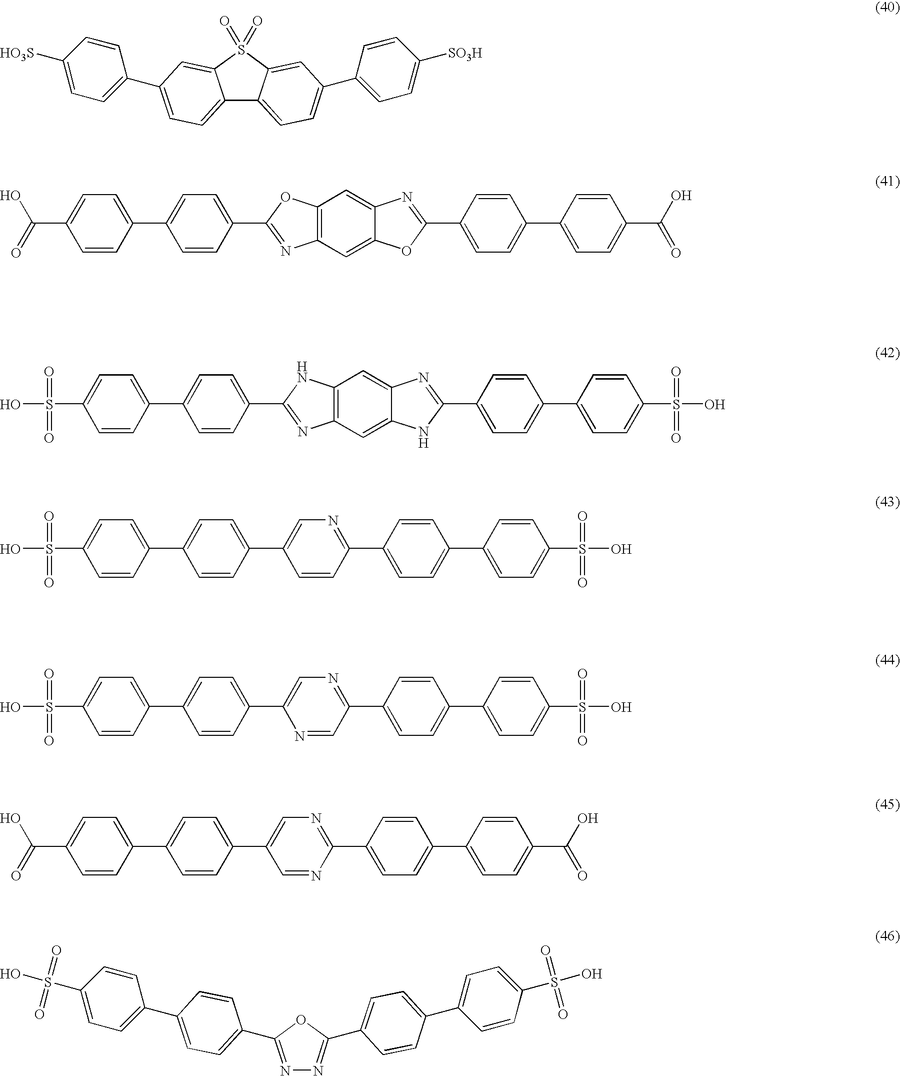

31. An anisotropic polymer film according to any of claims 1 to 30, further comprising anisometric particles formed by strong noncovalent chemical bonds formed between heterocyclic molecular systems via said binding groups.

32. An anisotropic polymer film according to claim 31, wherein said anisometric particles contain binding groups capable of forming labile noncovalent chemical bonds.

33. An anisotropic polymer film according to any of claims 31 or 32, wherein said binding groups ensure the formation of flat anisometric particles.

34. An anisotropic polymer film according to any of claims 31 to 33, wherein said anisometric particles have the form selected from the list comprising disk, plate, lamella, ribbon or any combination thereof.

35. An anisotropic polymer film according to any of claims 31 or 32, wherein said anisometric particles have the configuration selected from the list comprising chain, needle, column or any combination thereof.

36. An anisotropic polymer film according to any of claims 31 to 35, wherein the anisometric particles are bound with the binding sites, which form donor-acceptor bonds of Dp-Ap type, where Dp is a proton donor and Ap is a proton acceptor.

37. An anisotropic polymer film according to any of claims 31 to 36, further comprising a three-dimensional network structure formed by strong and weak noncovalent chemical bonds between said anisometric particles via binding groups.

38. An anisotropic polymer film according to any of claims 31 to 37, wherein the strong noncovalent chemical bond type is selected from the list comprising coordination bond, ionic bond, ion-dipole interaction, multiple hydrogen bond, interaction via heteroatoms, and any combination thereof.

39. An anisotropic polymer film according to any of claims 37 or 38, wherein said weak noncovalent chemical bond type is selected from the list comprising single hydrogen bond, dipole-dipole interaction, cation-π interaction, van der Waals interaction, π-π interaction, and any combination thereof.

40. An anisotropic polymer film according to any of claims 1 to 39, further comprising column-like supramolecules formed via π-π interaction between the adjacent heterocyclic molecular systems, wherein said supramolecules are bound with the binding sites.

41. An anisotropic polymer film according to any of claims 1 to 40, further comprising column-like supramolecules formed via π-π interaction between the adjacent heterocyclic molecular systems, wherein said supramolecules are bound with the binding groups.

42. An anisotropic polymer film according to any of claims 40 or 41, wherein the column-like supramolecules are aligned in the substrate plane.

43. An anisotropic polymer film according to any of claims 40 or 41, wherein longitudinal axes of the column-like supramolecules are directed perpendicularly in relation to the substrate plane.

44. An anisotropic polymer film according to any of claims 1 to 43, wherein the stickers are selected from the list comprising ions of hydrogen, bases, alkali metals, transition metals, platinum-group metals, and rare-earth metals.

45. An anisotropic polymer film according to claim 44, wherein said stickers are selected from the list comprising NH₄⁺, Na⁺, K⁺, Li⁺, Ba²⁺, Ca²⁺, Mg²⁺, Sr²⁺, Zn²⁺, Zr⁴⁺, Ce⁴⁺, Y³⁺, Yb³⁺, Gd³⁺, Er³⁺, Co²⁺, Co³⁺, Fe²⁺, Fe³⁺, Cu²⁺, and mixtures thereof.

46. An anisotropic polymer film according to any of claims 1 to 45, wherein said anisotropic layer possesses anisotropic electrical conductivity.

47. An anisotropic polymer film according to any of claims 1 to 46, wherein said anisotropic layer possesses anisotropic mechanical properties.

48. An anisotropic polymer film according to any of claims 1 to 47, wherein said anisotropic layer possesses anisotropic magnetic susceptibility.

49. An anisotropic polymer film according to any of claims 1 to 48, wherein said anisotropic layer is generally a biaxial retardation layer transparent in the visible spectral range.

50. An anisotropic polymer film according to any of claims 1 to 487, wherein said anisotropic layer is generally a uniaxial retardation layer transparent in the visible spectral range.

51. An anisotropic polymer film according to any of claims 1 to 48, wherein said anisotropic layer exhibits anisotropic optical absorption in the visible spectral range.

52. An anisotropic polymer film according to any of claims 1 to 51, wherein said anisotropic layer is generally a biaxial retardation layer transparent in the Near-UV spectral ranges.

53. An anisotropic polymer film according to any of claims 1 to 51, wherein said anisotropic layer is generally a uniaxial retardation layer transparent in the Near-UV spectral ranges.

54. An anisotropic polymer film according to any of claims 1 to 51, wherein said anisotropic layer exhibits anisotropic optical absorption in the UV spectral ranges.

55. An anisotropic polymer film according to any of claims 1 to 54, wherein said anisotropic layer is generally a biaxial retardation layer transparent in the near IR spectral range.

56. An anisotropic polymer film according to any of claims 1 to 54, wherein said anisotropic layer exhibits anisotropic optical absorption in the near IR spectral range.

57. An anisotropic polymer film according to any of claims 1 to 56, wherein the substrate is made of a polymer.

58. An anisotropic polymer film according to any of claims 1 to 56, wherein the substrate is made of a glass.

59. An anisotropic polymer film according to any of claims 50 to 58, wherein the anisotropic layer is applied on the front surface of the substrate and the rear surface of the substrate is coated with an antireflection or antiglare coating.

60. An anisotropic polymer film according to any of claims 50 to 58, wherein the anisotropic layer is applied on the front surface of the substrate, and the film further comprises a reflective layer applied onto the rear surface of the substrate.

61. An anisotropic polymer film according to any of claims 50 to 58, wherein the substrate is a specular or diffusive reflector.

62. An anisotropic polymer film according to any of claims 50 to 58, wherein the substrate is a reflective polarizer.

63. An anisotropic polymer film according to any of claims 1 to 62, further comprising a planarization layer applied onto the front surface of the substrate.

64. A method of fabricating an anisotropic polymer film comprising the steps of:
(i) preparing a substrate and
(ii) forming of a solid layer of a noncovalently bound polymeric material on the substrate by means of a Cascade Polymerization process which comprises the steps of:
(a) preparation of a reaction mixture of general composition (II): 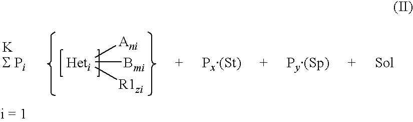
where Hetᵢ is a heterocyclic molecular system of the i-th kind,
K is the number of different kinds of heterocyclic molecular systems in the mixture and is equal to 1, 2, 3, 4, 5 or 6,
i is an integer in the range from 1 to K,
P₁, P₂, . . . P_{K} are real numbers in the range from 0 to 1 and obeying the condition: Pᵢ+P₂+ . . . +P_{K}=1,
A is a molecular binding group, n being 2, 3, 4, 5, 6, 7, or 8,
B is a molecular group ensuring solubility of the heterocyclic molecular system, m being 0, 1, 2, 3, 4, 5, 6, 7, or 8,
R1 is a substituent group from the list comprising —CH₃, —C₂H₅, ═NO₂, —CI, —Br, —F, —CF₃, —CN, —CNS, —OH, —OCH₃, —OC₂H₅, —OCOCH₃, —OCN, —SCN —NH₂, —NHCOCH₃, and —CONH₂, z being 0, 1, 2, 3, or 4,
St is a molecular group serving as a sticker,
Px is a real number in the range from 0 to 1,
Sp is a molecular group serving as a stopper,
Py is a real number in the range from 0 to 1, and
Sol is a solvent;
(b) application of a liquid layer of the reaction mixture onto the substrate, and
(c) drying.

65. A method according to claim 64, further comprising a step of the application of an external alignment action upon the deposited liquid layer in order to provide predominant alignment of said binding groups.

66. A method according to claim 65, wherein the deposition and alignment steps are carried out simultaneously.

67. A method according to any of claims 64 to 65, wherein said molecular binding group A is anisotropically polarizable.

68. A method according to any, of claims 64 to 67, wherein at least one of said binding groups is an acid binding group.

69. A method according to claim 68, wherein said at least one acid binding group is selected from the list comprising carboxylic (COO⁻), sulfonic (SO₃⁻), and phosphoric (PO₃²⁻ and HPO₃⁺) groups, and any combination thereof.

70. A method according to any of claims 64 to 69, wherein at least one of said binding groups is a basic binding group.

71. A method according to claim 70, wherein said at least one basic binding group is selected from the list comprising CONHCONH₂, NHR, NR₂, CONH₂ and any combination thereof, where radical R is selected from the list comprising hydrogen, alkyl and aryl.

72. A method according to claim 71 wherein the alkyl groups have the general formula CH₃(CH₂)ₙ— or CₙH₂ₙ₊₁—, where n is equal to from 1 to 23.

73. A method according to claim 71 wherein the aryl group is selected from the list comprising phenyl, benzyl and naphthyl groups.

74. A method according to claim 71 or 72 wherein the alkyl group is selected from the list comprising methyl, ethyl, propyl, i-propyl, butyl, i-butyl, s-butyl and t-butyl groups.

75. A method according to any of claims 67, 68 or 70, wherein at least one of said binding groups is a complementary group.

76. A method according to any of claims 64 to 75 wherein the groups B provide solubility of the heterocyclic molecular system in water or water miscible solvents, and are selected from the list comprising COO⁻, SO₃⁻, HPO₃⁻ and PO₃²⁻ and any combination thereof.

77. A method according to any of claims 64 to 75 wherein the groups B provide solubility of the heterocyclic molecular system in organic solvents, and are selected from the list comprising CONHCONH₂, CONR2R3, SO₂NR2R3, CO₂R2, R2 or any combination thereof, wherein R2 and R3 are selected from hydrogen, alkyl, and aryl.

78. A method according to any of claims 64 to 77, wherein at least one kind of said heterocyclic molecular systems is partially or completely conjugated.

79. A method according to any of claims 64 to 78, wherein at least one kind of said heterocyclic molecular systems contains the heteroatoms, which serve as binding sites and are selected from the list comprising nitrogen, oxygen, sulfur, and any combination thereof.

80. A method according to any of claims 64 to 79, wherein at least one kind of said heterocyclic molecular systems is predominantly flat.

81. A method according to claim 80, wherein at least one kind of said heterocyclic molecular systems has the form selected from the list comprising disk, plate, lamella, ribbon or any combination thereof.

82. A method according to any of claims 64 to 81, wherein at least one kind of said heterocyclic molecular systems possesses lyophilic properties.

83. A method according to any of claims 64 to 81, wherein at least one kind of said heterocyclic molecular systems possesses lyophobic properties.

84. A method according to any of claims 64 to 83, wherein at least one kind of said heterocyclic molecular systems has no less than three binding groups.

85. A method according to any of claims 64 to 84, wherein the heterocyclic molecular system has an axis of symmetry of order k (Cₖ) directed perpendicularly with respect to the plane of heterocyclic molecular system, where k is the number no less than 3.

86. A method according to any of claims 64 to 85, wherein the heterocyclic molecular system is predominantly planar and comprises pyrazine or/and imidazole cycles and has a general structural formula from the group comprising structures 1-5:

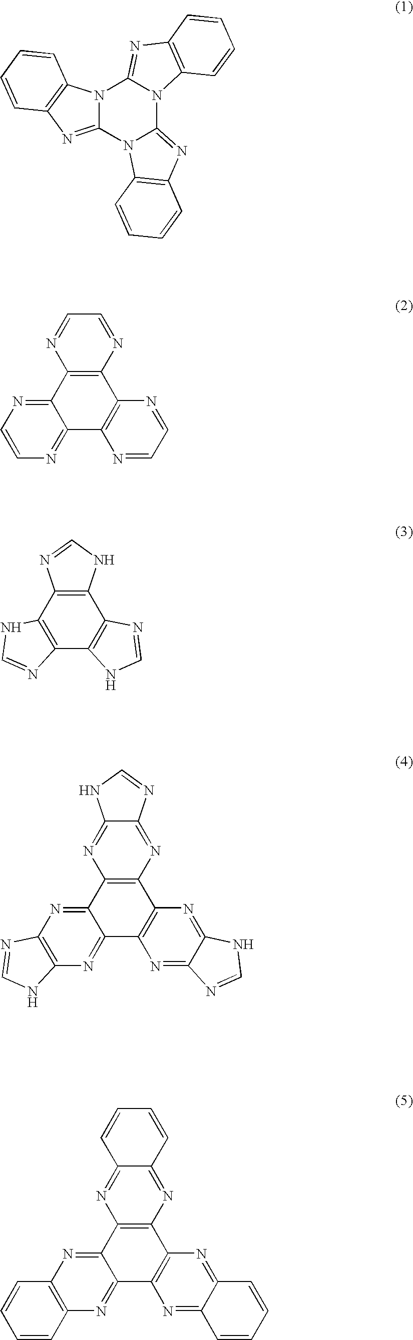

87. A method according to any of claims 64 to 84, wherein the heterocyclic molecular system is an oligomer comprising imidazole or/and benzimidazole cycles, which are capable of forming hydrogen bonds.

88. A method according to claim 87, wherein the heterocyclic molecular system is predominantly planar and comprises imidazole and/or benzimidazole cycles having a general structural formula corresponding to any one or more of structures 6-15, where n is the number in the range from 1 to 20:

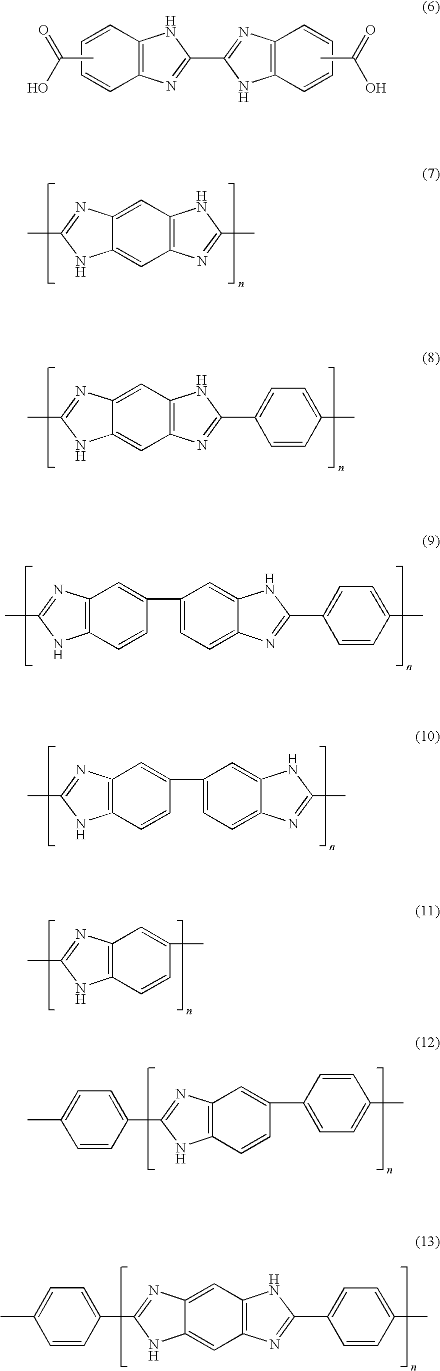

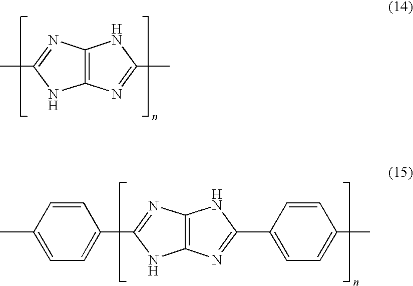

89. A method according to any of claims 64 to 84, wherein the heterocyclic molecular system is a tetrapirolic macrocycle.

90. A method according to claim 89, wherein the heterocyclic molecular system is predominantly planar and comprises tetrapirolic macrocycles having a general structural formula corresponding to any one or more of structures 16-21, where the M denotes atom of metal or denotes two protons:

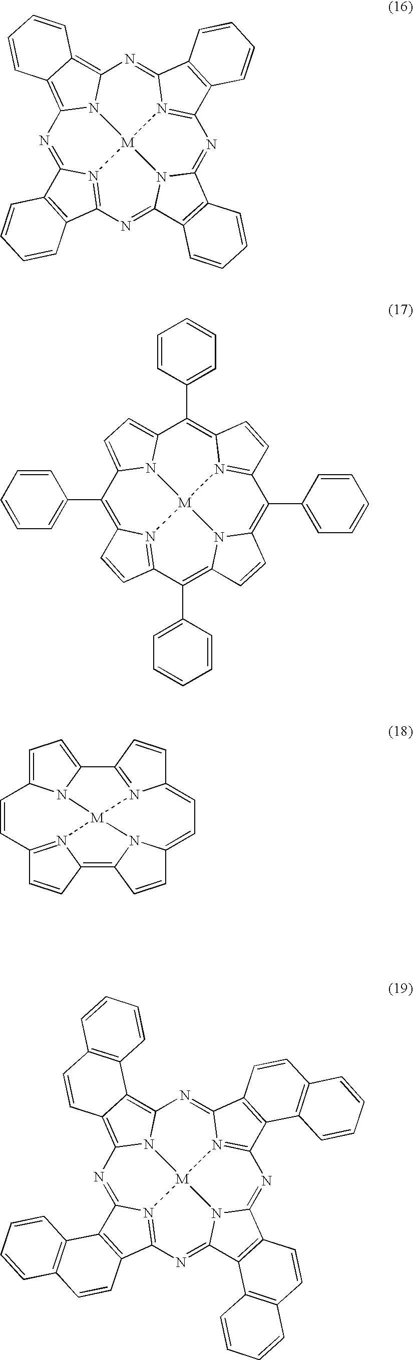

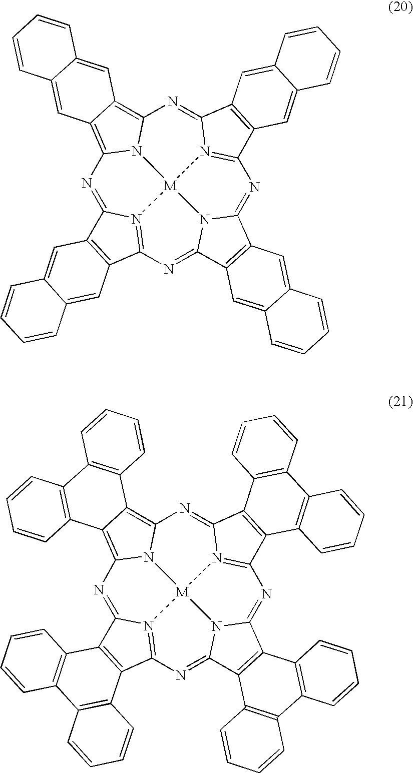

91. A method according to any of claims 64 to 84, wherein the heterocyclic molecular system comprises rylene fragments.

92. A method according to claim 91, wherein the heterocyclic molecular system is predominantly planar and comprises rylene fragments having a general structural formula corresponding to any one or more of structures 22-39, where the M denotes atom of metal or denotes two protons:

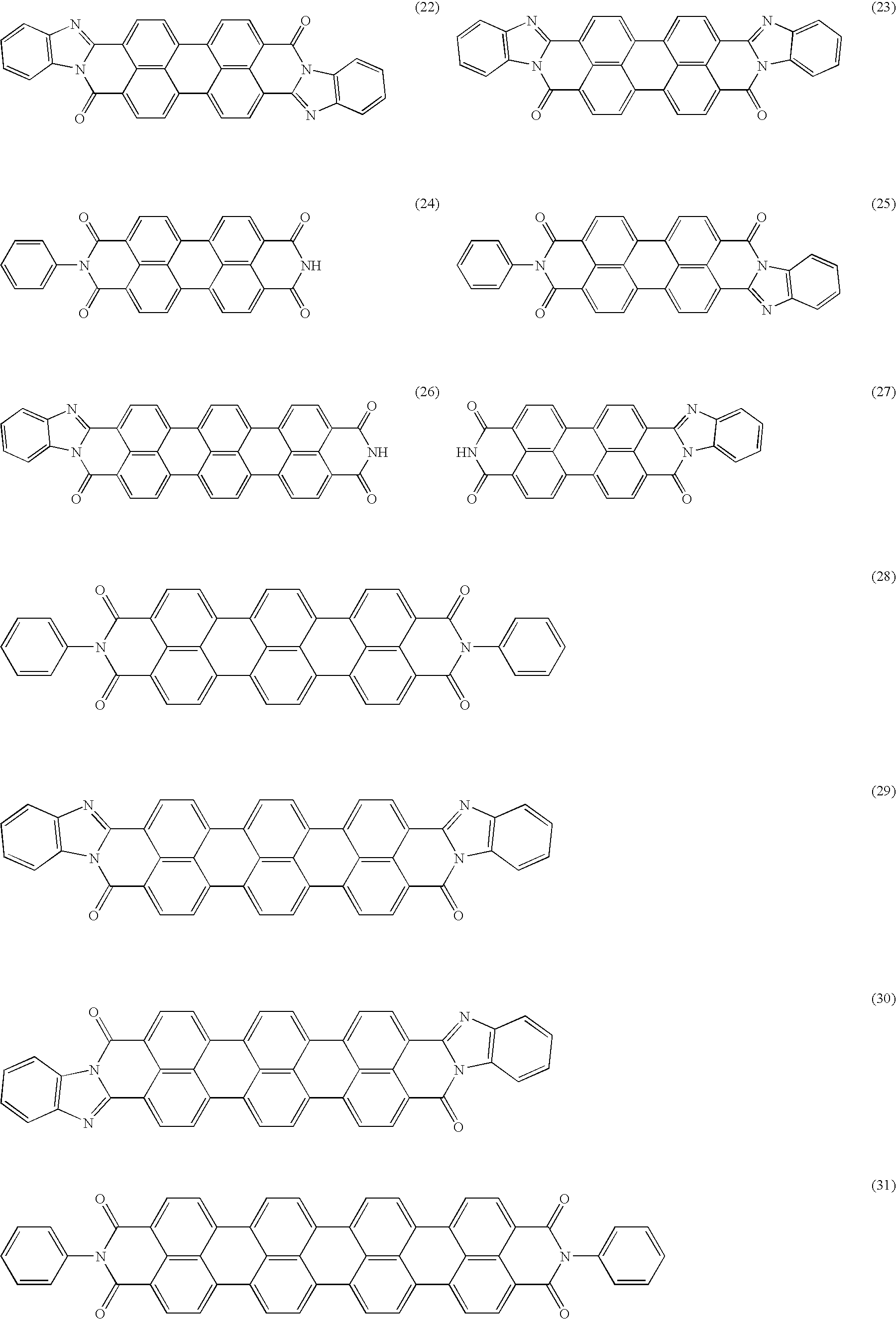

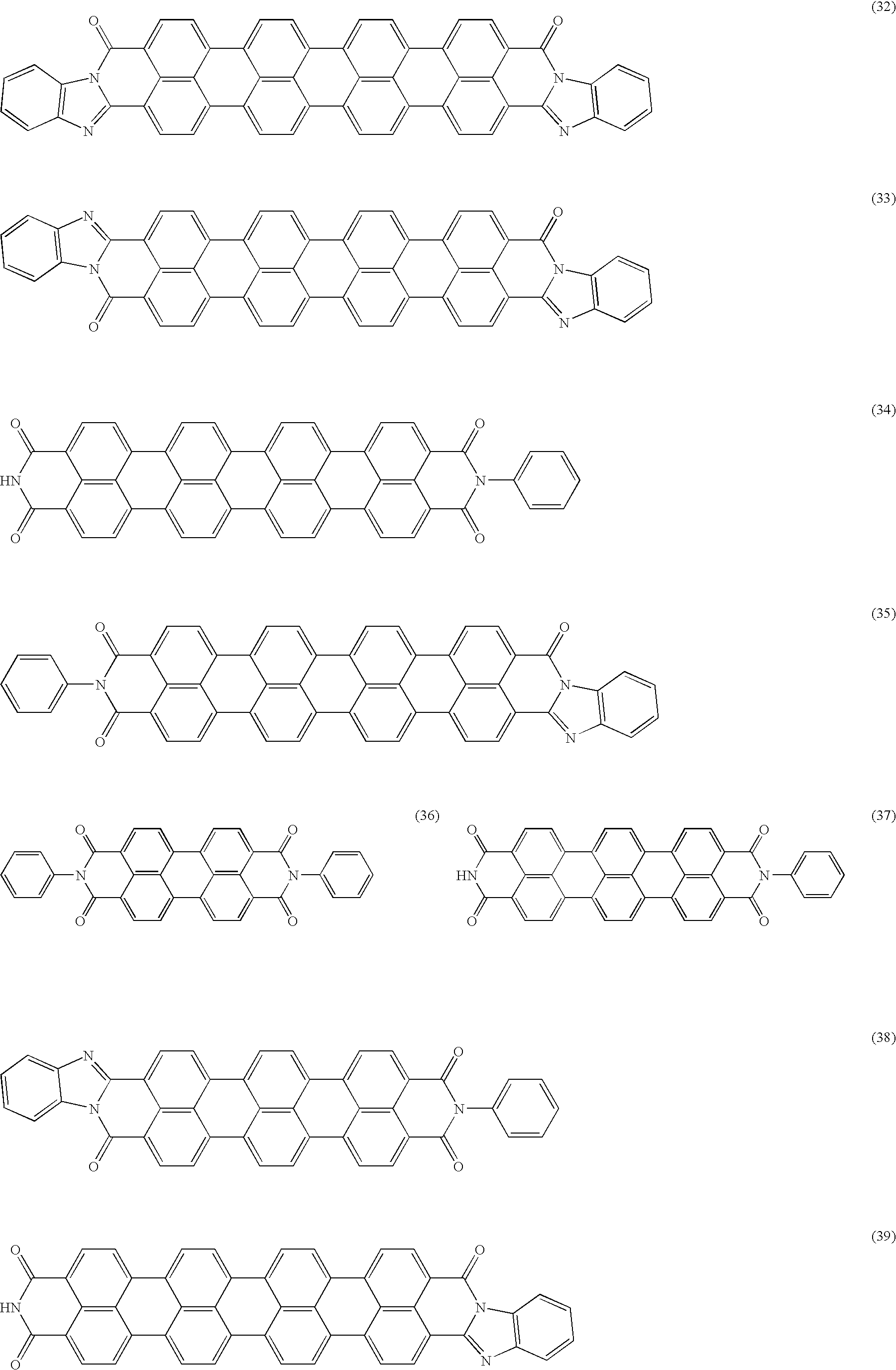

93. A method according to any of claims 64 to 84, wherein the organic compound is an oligophenyl derivative.

94. A method according to claim 93, wherein the oligophenyl derivative has a general structural formula corresponding to one of structures 40 to 46:

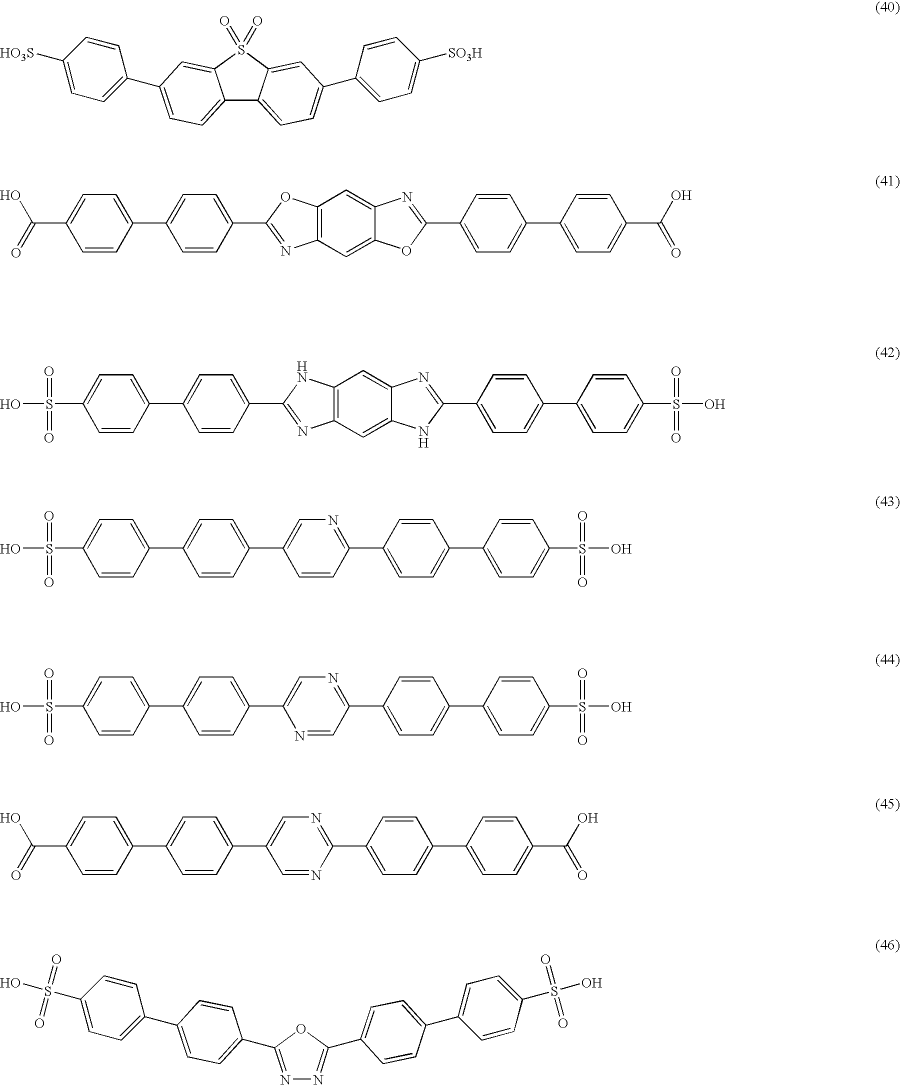

95. A method according to any of claims 64 to 94, wherein the step (a) further comprises formation of anisometric particles from organic molecules by means of binding groups via strong noncovalent chemical bonds.

96. A method according to claim 95, wherein at least one of said binding groups provides a labile equilibrium of anisometric particles with the reaction mixture.

97. A method according to any of claim 95 or 96, wherein said binding groups provide the formation of flat anisometric particles.

98. A method according to any of claims 95 or 96, wherein said anisometric particles have a configuration selected from the list comprising chain, needle, plate, column, lamella and ribbon or any combination thereof.

99. A method according to any of claims 95 to 98, wherein step (b) further comprises the binding of the anisometric particles via the binding sites, which form donor-acceptor bonds of Dp-Ap type, where Dp-donor of proton and Ap-acceptor of proton.

100. A method according to any of claims 95 to 99, wherein step (b) further comprises the formation Of a three-dimensional network structure from anisometric particles by means of binding groups via strong and weak noncovalent chemical bonds.

101. A method according to any of claims 95 to 100, wherein said strong noncovalent chemical bond types are selected from the list comprising coordination bond, ionic bond, ion-dipole interaction, multiple hydrogen bond, interaction via heteroatoms, and any combination thereof.

102. A method according to claim 100, wherein said weak noncovalent chemical bond types are selected from the list comprising single hydrogen bond, dipole-dipole interaction, cation-π interaction, van der Waals interaction, π-π interaction, and any combination thereof.

103. A method according to any of claims 64 to 102, wherein the step (a) further comprises the forming of column-like supramolecules formed via π-π interaction between the adjacent heterocyclic molecular systems, wherein said supramolecules are bound with the binding sites.

104. A method according to any of claims 64 to 102, wherein the step (a) further comprises the forming of column-like supramolecules formed via π-π interaction between the adjacent heterocyclic molecular systems, wherein said supramolecules are bound with the binding groups.

105. A method according to any of claims 103 or 104, wherein the column-like supramolecules are aligned in the substrate plane.

106. A method according to any of claims 103 or 104, wherein longitudinal axes of the column-like supramolecules are directed perpendicularly in relation to the substrate plane.

107. A method according to any of claims 64 to 106, wherein the stickers are selected from the list comprising ions of hydrogen, bases, alkali metals, transition metals, platinum-group metals, and rare-earth metals.

108. A method according to claim 107, wherein the stickers are selected from the list comprising H⁺, NH₄⁺, Na⁺, K⁺, Li⁺, Ba²⁺, Ca²⁺, Mg²⁺, Sr²⁺, Zn²⁺, Zr⁴⁺, Ce⁴⁺, Y³⁺, Yb³⁺, Gd³⁺, Er³⁺, Co²⁺, Co³⁺, Fe²⁺, Fe³⁺, and Cu²⁺.

109. A method according to any of claims 65 to 108, wherein the external alignment action on the deposited liquid layer is performed via mechanical action.

110. A method according to claim 109, wherein the mechanical action on the deposited liquid layer is performed with use the equipment selected from the list comprising slot die machine, extrusion machine, and molding machine.

111. A method according to claim 110, wherein the velocity of a hydrodynamic flow of the reaction mixture during extrusion provides reduction of the viscosity of said mixture.

112. A method according to any of claims 65 to 111, wherein the external alignment action on the deposited layer is performed with the use of mechanical translation over the layer of at least one aligning tool and the distance from the substrate surface to the edge or the plane of the aligning tool is set so as to obtain desired film thickness.

113. A method according to claim 112, wherein the aligning tool is heated.

114. A method according to any of claims 64 to 113, wherein the concentrations of the heterocyclic molecular systems, binding groups, and stickers in the reaction mixture are chosen such as to provide thixotropy of the reaction mixture.

115. A method according to any of claims 64 to 114, further comprising a special treatment of the solid layer in order to ensure insolubility to the anisotropic polymer film.

116. A method according to any of claims 64 to 115, wherein the applied reaction mixture is in a gel form.

117. A method according to any of claims 64 to 115, wherein the applied reaction mixture is in a viscous liquid form.

118. A method according to any of claims 64 to 117, wherein the solvent is water.

119. A method according to any of claims 64 to 117, wherein the solvent is selected from the list comprising acetone, acetonitrile, benzene, dimethyl sulfoxide, dimethyl formamide, diethyl ether, methanol, nitrobenzene, nitromethane, pyridine, propylene carbonate, tetrahydrofuran, acetic acid, ethanol, methylene chloride, and any combination thereof.

120. A method according to any of claims 64 to 119, wherein the amount of solvent is controlled so as to provide the reaction mixture viscosity necessary for applying a liquid layer by means of a hydrodynamic flow.

121. A method according to claim 120, wherein the viscosity of the reaction mixture does not exceed 2 Pas.

122. A method according to any of claims 95 to 121, wherein said anisometric particles have linear dimensions not smaller than one micron.
